(19) United States
(12) Patent Application Publication
(10) Pub. No.: US 2025/0238662 A1
(43) Pub. Date: Jul. 24, 2025

(54) SYSTEMS AND METHODS FOR IMPROVING PLATFORMS INTERACTING WITH ARTIFICIAL INTELLIGENCE MODELS

(71) Applicant: Aible Inc., Pleasanton, CA (US)

(72) Inventors: Arijit Sengupta, San Carlos, CA (US); Jonathan Wray, Leander, TX (US); Joseph Veltkamp, Corte Madera, CA (US); Robert Shaw, Pleasanton, CA (US); Richard Cooke, Hayward, CA (US); John Delaney, El Cerrito, CA (US); Frank Taylor, Pleasanton, CA (US)

(21) Appl. No.: 19/034,303

(22) Filed: Jan. 22, 2025

Related U.S. Application Data
(60) Provisional application No. 63/700,332, filed on Sep. 27, 2024.
(60) Provisional application No. 63/645,403, filed on May 10, 2024.
(60) Provisional application No. 63/624,543, filed on Jan. 24, 2024.

(51) Int. Cl. G06N 3/0475; G06F 40/40

(52) U.S. Cl. CPC G06N 3/0475; G06F 40/40

(57) ABSTRACT

Data characterizing a prompt and/or a parameter set can be received. Data characterizing an enhanced prompt can be generated. The enhanced prompt can be stored in a template. When a change in ta type of the artificial intelligence based model, a setting of the artificial intelligence based model, or a configuration for an enterprise in which the artificial intelligence based model is deployed, is determined to be above a threshold, the enhanced prompt can be modified. The modified enhanced prompt can be provided to one or more applications interfacing with the artificial intelligence model, or derivative of the template. Related apparatus, systems, techniques, and articles are also described.

### CROSS-REFERENCE TO RELATED APPLICATIONS

This application claims the benefit of and priority under 35 U.S.C. § 119(e) to U.S. Provisional Patent Application Nos. 63/624,543, filed Jan. 24, 2024; 63/645,403, filed May 10, 2024; and 63/700,332, filed Sep. 27, 2024, and incorporates their disclosures herein by reference in their entireties.

### TECHNICAL FIELD

The subject matter described herein relates to improving platforms that interact with artificial intelligence models.

### BACKGROUND

Large scale artificial intelligence based models may include a vast number of parameters that are used to process and understand large quantities of data. For example, foundational models may incorporate large language models to utilize transformer-based deep learning algorithms that are trained on global repositories of data. These models can include generative artificial intelligence (AI) tools that are able to produce content including text, imagery, audio, and synthetic data. These tools often include user interfaces or user facing applications that receive prompts, settings, or other parameters that are used to interact with the underlying artificial intelligence based models, which are used to produce content. The quality of the output generated by the underlying artificial intelligence model can vary greatly based on the user provided prompt and selected settings and/or parameters.

For example, a generative model configured to generate an image may produce widely different outputs based on a user provided prompt of “draw a red door” in comparison to a user provided prompt of “draw a red door that is rounded and six feet tall for a house in the style of a children's book.” Similarly, a generative model configured to generate a text may produce differing outputs based on a user provided prompt of “write me a song” in comparison to a user prompt of “write me a song in the style of pop music about summer.” A generative model configured to generate a text with a setting of “conversational mode” will produce a different text than one in a setting of “formal mode.” In other words, the same prompt may also provide different outputs and produce outputs of different quality based on the settings utilized by the underlying artificial intelligence based model the prompt is being fed into.

### SUMMARY

In an aspect, a method includes receiving data characterizing a prompt from a user interface of a user application, wherein the data is in natural language form, generating data characterizing an enhanced prompt based on at least one of a type of an artificial intelligence based model interfacing with the user application, a setting of the artificial intelligence based model, or a configuration for an enterprise in which the artificial intelligence based model is deployed, modifying the enhanced prompt when a change in the type of artificial intelligence based model, a change in the setting of the artificial intelligence based model, or a change in a configuration for an enterprise in which the artificial intelligence based model is deployed is determined to be above a threshold, and providing the modified enhanced prompt to one or more applications interfacing with the artificial intelligence model.

One or more of the following features can be included in any feasible combination.

For example, the method can include determining a prompt response by providing the data characterizing the modified enhanced prompt to an artificial intelligence based model, and providing the prompt response. The artificial intelligence based model can include at least one of a foundational model, a multimodal model, a reinforcement learning model, a transfer learning model, or a large language model. The prompt response can be provided to a user interface in natural language form. In some aspects, the prompt response is augmented with external data.

In some aspects, providing the modified enhanced prompt to one or more applications interfacing with the artificial intelligence model further includes: associating the artificial intelligence model with one or more applications interacting with the artificial intelligence model; and providing a change to the modified enhanced prompt to the one or more applications associated with the artificial intelligence model.

In some aspects, generating data characterizing an enhanced prompt includes historical prompt data, wherein the historical prompt data includes at least one of prior prompts, prior responses, and user feedback indicating relevancy of prior responses.

In some aspects, the method also includes displaying at least one of the prompt, the enhanced prompt, or the modified enhanced prompt in a graphical user interface.

In some aspects, generating data characterizing an enhanced prompt includes receiving few shot data and the method includes providing few shot data to the artificial intelligence model.

In some aspects, the prompt response is change-resistant.

In some aspects, the setting of the artificial intelligence based model includes at least one of a temperature, frequency penalty, presence penalty, top P-value, or top K-value.

In some aspects, the enhanced prompt specifies visibility and access settings for the artificial intelligence based model.

In some aspects, a method includes linking one or more user applications to a first user application of the one or more applications interfacing with the artificial intelligence model; and automatically modifying enhanced prompts for the linked one or more user applications responsive to the first user application receiving the provided modified enhanced prompt.

In some aspects, the user application is configured to provide one or more of document summarization, natural language query, what's new analysis and/or analytics.

In some aspects, the enhanced prompt includes a dataset object, outcomes of the dataset object, and/or parameters for a prompt response.

In some aspects, the parameters for the prompt response include a tone, a cadence, and/or narrative styles.

In some aspects, the method also includes providing the modified enhanced prompts to a user via a graphical user interface; and receiving feedback to the provided modified enhanced prompts from the user via the graphical user interface, wherein the feedback includes text, icon selections and/or adjustments to parameter settings.

In some aspects, the method includes generating training data for at least one of an enhanced prompt generator and/or the artificial intelligence based model based on the modified enhanced prompt when the received feedback is positive.

In another aspect, a method includes receiving data including one or more parameter sets for a user application interfacing with an artificial intelligence based model, wherein a parameter set among the one or more parameter sets includes one or more values indicating at least one of a type of the artificial intelligence based model, a setting of the artificial intelligence based model, or a configuration of the artificial intelligence based model; generating data characterizing performance of the user application for the one or more parameter sets; and providing the data characterizing performance of the user application.

One or more of the following features can be included in any feasible combination.

For example, the method can include receiving user feedback characterizing performance of the user application. The method can also include updating the artificial intelligence based model using at least one of the received user feedback and/or the provided parameter set.

In some aspects, the artificial intelligence based model includes at least one of a foundational model, a multimodal model, a reinforcement learning model, a transfer learning model, or a large language model. The method can include monitoring the performance of one or more user applications including the user application for the one or more parameter sets. The method can also include displaying at least one of the parameter set and/or data characterizing performance of the user application in a graphical user interface.

In some aspects, the method can include updating a prompt generator using at least one of the received user feedback and/or the provided parameter set.

In some aspects, the configuration of the artificial intelligence based model includes a chat tone indicating that a response generated by the user application is at least one of: a narrative format, a bullet point list, a story format, in a short and punchy format, or a business format. In some aspects, the configuration of the artificial intelligence based model indicates whether the artificial intelligence based model recalls previous queries and their respective answers for context. In some aspects, the configuration of the artificial intelligence based model specifies access and security parameters for the artificial intelligence based model.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating an exemplary method of generating enhanced prompts for use with artificial intelligence based systems;

FIG. 2A is a system block diagram illustrating an example system;

FIG. 2B is a system block diagram illustrating an example system;

FIGS. 3-22 illustrate various example user interfaces illustrating example implementations of the current subject matter;

FIG. 23 is a system block diagram illustrating an example implementation of a system for improved applications utilizing artificial intelligence models;

FIG. 24 provides a block-diagram illustrating a process for improving applications that interface with artificial intelligence based models;

FIGS. 25A-25D illustrate various examples of user interfaces illustrating example implementations of the current subject matter;

FIGS. 26A-26C illustrate various examples of user interfaces illustrating example implementations of the current subject matter; and

FIGS. 27A-27B illustrate various examples of user interfaces illustrating example implementations of the current subject matter.

Like reference symbols in the various drawings indicate like elements.

### DETAILED DESCRIPTION

Artificial intelligence (AI) based models may include multimodal models, large language models, chatbots, voice assistants, and the like. Generative AI based systems include applications that are capable of producing content such as text, imagery, audio, and synthetic data. User applications that interface with an artificial intelligence (AI) based model are often configured to receive a prompt from a user, query an underlying AI-based model, in order to generate an output that is responsive to the user's prompt. While AI-based models are broadly adopted, they continue to produce outputs of varying quality. Some implementations of the current subject matter can improve the output quality and results from user software applications that utilize AI-based models.

In some implementations, user applications that interface with AI-based models can be improved using enhanced systems and methods for prompt engineering, linked learning, and through systems and methods for improved selection of parameter settings. In some embodiments, the selection of prompts and/or parameter settings may moderate interactions between the user application and the underlying AI-based models. Improved prompts, learning and selection of parameter settings may result in a user application or platform receiving improved outputs from AI-based models, which face challenges in producing salient, relevant and efficient outputs in shorter timespans in response to user-generated prompts.

Prompt engineering can refer to the practice of developing and optimizing prompts such that they can more effectively use the underlying generative AI models such as large language models. Prompts can be optimized to generate better responses based on one or more metrics. Examples of metrics include the saliency, relevancy, context, or computational time required to generate a response. The underlying generative AI models, such as large language models, are continuously evolving. Thus, a prompt determined to produce a good or optimal response using prompt engineering can produce diminishing results overtime as the underlying generative AI model evolves. Additionally, applications layered between a large language model and user facing applications may malfunction when the large language model evolves. For example, a large language model may evolve when it receives additional data, incorporates additional algorithms, is updated, modified, or the like. In these cases, some prior systems require the manual modification or updating of the applications layered between a large language model and a user facing application, or of a prompt that was engineered to interface with the generative AI model. Such manual modification or updating of applications can be cumbersome, cost-prohibitive, prevent full utilization of large language model capabilities, and the like.

Some implementations of the current subject matter include generating improved prompts or enhanced queries for use with an artificial intelligence system that are change-resistant. Change-resistant may refer to the fact that the prompts can be modified to provide enhanced prompts that can provide better outputs from artificial intelligence systems, even as the artificial intelligence systems themselves are modified or undergo change.

In exemplary implementations, the disclosed subject matter may be used to generate change-resistant enhanced user prompts that are able to utilize context specific language and allow businesses to use artificial intelligence models that are enterprise specific. Further, the generated user prompts can be change-resistant in that they are able to provide prompts that are applicable to an AI based generative model even when the model has been updated.

Additionally, in some exemplary implementations the generated user prompts can be propagated across multiple applications that interface with the AI based generative model. For example, one or more applications can be built from a default or custom template that utilizes prompt engineering. These applications can be designated as children of the default or custom template. In some implementations, as the default or custom template is updated to interface with an updated artificial intelligence based model, all children of the default or custom template can also be automatically updated. In this manner, some of the exemplary implementations discussed herein can provide advantages over prior systems that required the manual adjustment of prompts after the underlying artificial intelligence based models were updated.

AI based generative models may provide different outputs and produce outputs of different quality based on the specific artificial intelligence based model that the prompt is being fed into. For example, the same prompt may not produce the same quality of output in a first artificial intelligence model such as GPT-4 in comparison to a second artificial intelligence model such as PaLM2, and the like.

Additionally, the same prompt may also provide different outputs and produce outputs of different quality based on the settings utilized by the underlying artificial intelligence based model the prompt is being fed into. For example, an artificial intelligence model such as a large language model may produce different outputs for a prompt depending on the underlying settings of the large language model. For example, if the temperature settings of the large language model is changed from low temperature to high temperature, the same prompt may result in a different quality of output.

The quality of a response generated by an artificial intelligence based model may be evaluated on the creativity of the AI response, the amount of hallucinations generated by the AI model, the accuracy of facts produced by the AI model, the responsiveness of the AI model to the prompt, how well the AI followed user instructions, the speed of the response or the computational requirements (e.g., processing power and time), and the like.

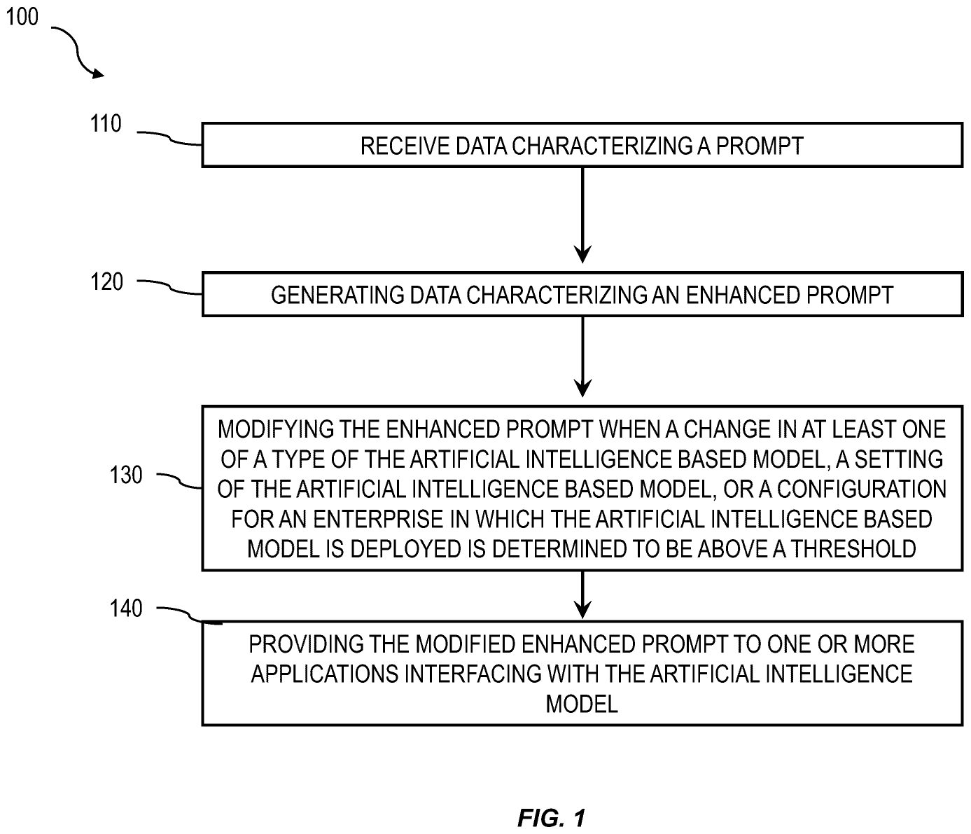

FIG. 1 is a process flow diagram illustrating an exemplary method 100 of generating enhanced prompts for use with artificial intelligence based systems.

In a first step 110 of the exemplary method, data characterizing a prompt can be received. For example, in some embodiments a user interface may be configured to receive a text, voice, or other prompt from a user. In some embodiments, the received prompt may be in natural language form. The generative AI systems may produce outputs in the same medium in which it is prompted (e.g., text to text) or in a different medium (e.g., text to image).

In a second step 120 of the exemplary method, data characterizing an enhanced prompt can be generated based on the received data characterizing a prompt. For example, a user may provide a prompt to an artificial intelligence based model such as “what drives higher sales success?” and the disclosed example methods can generate an enhanced prompt that may produce better and more relevant responses from the artificial intelligence based model. These responses can then be provided to a user. Enhanced prompts can specify context for the query, provide background information for use with the underlying artificial intelligence based model, and set expectations around the expected response to the query.

In some embodiments, generating the enhanced prompt may include modifying the received data characterizing a prompt based on a type of the artificial intelligence based model. Artificial intelligence based models may include generative AI models. Examples of generative AI models include large language models, foundational models, and the like. Examples of generative AI models include ChatGPT, GPT-3, GPT-4, PaLM 2, GPT-J, Dolly 2, Gemini, DALL-E, Bard/LaMDA, Midjourney, DeepMind, and the like. Generative AI models may include one or more machine learning techniques such as neural networks, generative adversarial networks (GANs), transformers, autoencoders, and the like.

In some embodiments, generating the enhanced prompt may include modifying the received data characterizing the prompt based on a setting of the artificial intelligence based model. For example, in a learning language model, settings may include the temperature, frequency penalty, presence penalty, top P-value, or top K-value.

In some embodiments, historical user behavior including historical data analysis characteristics may be received, and a blueprint for guiding user action to modify the prompt may be generated based on the historical user behavior. For example, data characterizing how an expert user navigated and generated user queries may be used to develop a process for generating enhanced queries. For example, the metadata from historical interactions for using queries with an AI model may be used to determine templates that can be used to develop enhanced queries.

In some embodiment, generating the enhanced prompt may include modifying the received data characterizing the prompt based on a configuration for an enterprise in which the artificial intelligence based model is deployed. For example, in generating the enhanced prompt, enterprise specific practices may be applied. For example, the prompt may be modified to specify that a response generated by the AI-based model should use colloquial or formal language, remove slang terms, or the like. Additionally, the enhanced prompt may be configured to mask sensitive or proprietary data that the enterprise does not wish to share with the artificial intelligence based model. In other words, the enhance prompt may specify visibility and access settings for the underlying AI-based model that specify the files and/or databases of the user the AI-based model may have access to.

Enhanced prompts can be stored in templates. Templates can include default or custom templates. One or more applications can be built on a default or custom template that utilizes prompt engineering. These applications can be designated as children of the default or custom template. Prompt augmentation or enhancing prompts may allow users to enter definitions that provide usage notes to the underlying model. The resulting enhanced prompts or changes can be propagated to the applications that are designed as children of the default or custom template. For example, an enhanced prompt can be linked to a particular template. The enhanced prompt can be updated as the underlying artificial intelligence model is updated. Any changes to the enhanced prompt corresponding to the template can be propagated to applications that are designated as the children of the template. In some embodiments, the changes can be uni-directional. For example, any changes made to prompts corresponding to designated children of the template may not be propagated upwards to the parent template.

In some implementations, as the default or custom template is updated to interface with an updated artificial intelligence based model, all children of the default or custom template can also be automatically updated. In some implementations, the adjustments to the enhanced prompts made by the users can be saved in the form of templates and propagated throughout all user applications in the lineage of that template in order to make global systemic changes to the enhanced prompts. Templates can include system instructions for interaction with the underlying artificial intelligence model.

In a third step 130 of the exemplary method, the enhanced prompt can be modified based on at least one of the following: when there is a change to the type of artificial intelligence based model, the setting of the artificial intelligence based model, or a configuration for an enterprise in which the artificial intelligence based model is deployed. The modification of the enhanced prompt can be initiated when it is determined that changes to the type of artificial intelligence based model, a setting of the artificial intelligence based model, or the configuration exceeds a threshold.

In some embodiments, changes in the underlying AI model or settings can be detected by receiving notification of an update to the AI model or by receiving feedback that interactions with the underlying AI model are impaired. In some embodiments, artificial intelligence models can include floating models that are continuously tuned. The floating models can be tuned as frequently as day-to-day, week-to-week or the like. As the floating models are tuned, they may drift such that the original enhanced prompt is no longer effective. Accordingly, the enhanced prompt can be updated such that it is compatible with the tuned floating model. In some embodiments, the underlying AI model includes a pinned model that is pinned to a certain date and are updated/deprecated. Accordingly, the enhanced prompt can be updated such that it is compatible with the updated/deprecated underlying AI model. Some example implementations may determine that the enhanced prompt is no longer effective based on assessing performance of the system using the enhanced prompt and/or user feedback. User feedback can include user input via a graphical user interface indicating a quality of response (e.g., thumbs up/down).

The updated modified enhanced prompt can be generated analogous to the methodology used to generate initial enhanced prompts. In some embodiments, updating a modified enhanced prompt can include replacing an existing prompt. The updated modified prompt may receive different information, settings, and configuration information corresponding to the underlying artificial intelligence model.

In a fourth step, 140 the modified enhanced prompt can be provided to one or more applications interfacing with the artificial intelligence model. For example, the information is passed to the applications and wrapped. In some implementations, the information can be retrieved by an application when it wants to access the artificial intelligence model. In some embodiments, the modified enhanced prompt can be from a custom or default template and the modified enhanced prompt can be propagated to linked applications or templates that are labeled as child templates.

In some implementations a prompt response may be determined by providing the data characterizing the modified enhanced prompt to an artificial intelligence based model.

For example, the artificial intelligence based model may include a model that is an informational model that has access to enterprise specific information. Enterprise specific information may include data on the variables and parameters that impact key performance indicators for an enterprise. Variables and parameters can include sales expenditure, marketing expenditure, revenue, win rate, statistics, inventory levels, logistics datasets, collections metrics, lead conversions, and the like. The information model can include descriptive models, diagnostic models, predictive models, optimization models, prescriptive models, cost-benefit models, and/or constraint models. Optimization models may include those that balance cost-benefits of predictive models subject to business constraints. The information model may produce one or more charts that provide insight into how an enterprise may be affected under different strategies and cost benefit assumptions. For example, information models may include those discussed in U.S. patent application Ser. No. 16/512,647 filed on Jul. 16, 2019, entitled “ANALYZING PERFORMANCE OF MODELS TRAINED WITH VARYING CONSTRAINTS” the contents of which are hereby incorporated by reference, in their entirety. For example, information models can include a set of models trained on a dataset using a set of resourcing levels, which may specify a condition on outputs of models in the set of models.

In some implementations, the artificial intelligence based model may include a model that is a foundational model, a class of large language models, a generative model, a reinforcement learning model, transfer learning model, generative AI based technologies, and the like. In some embodiments, the artificial intelligence based model may be used on a global learning model that is trained on a vast quantity of data. The artificial intelligence based model may utilize various learning algorithms including supervised learning and unsupervised techniques. The model may be trained on vast quantities of data. Examples of artificial intelligence based models include foundation models that utilize large language models and generative models that are trained using transformer based deep learning techniques. Foundation models can also be included in frontier models which are large scale advanced artificial intelligence models.

In some implementations, the prompt response can be provided. For example, in some embodiments, the prompt response may be provided to a user interface. In some embodiments, the prompt response may be provided to a user interface in natural language form. Accordingly, a user may be able to use conversational language with some implementations of the current subject matter.

In some embodiments, the user interface may include any hardware or software components for communication between a user and the system described herein.

Examples of user interfaces include applications, software programs, web applications, downloadable applications, and the like that may be present on a user interface device.

Examples of user interface devices, include, but are not limited to laptops, desktop computers, smartphones, tablets, car service devices, television devices, video game controller systems, coffee machines, refrigerators, and the like. The user interface may be in the form of a voice assistant, chat assistant, email assistant, image generation, and the like. In some embodiments, the user interface may allow for enterprise specific users or enterprise customer users to interact with the prompt response.

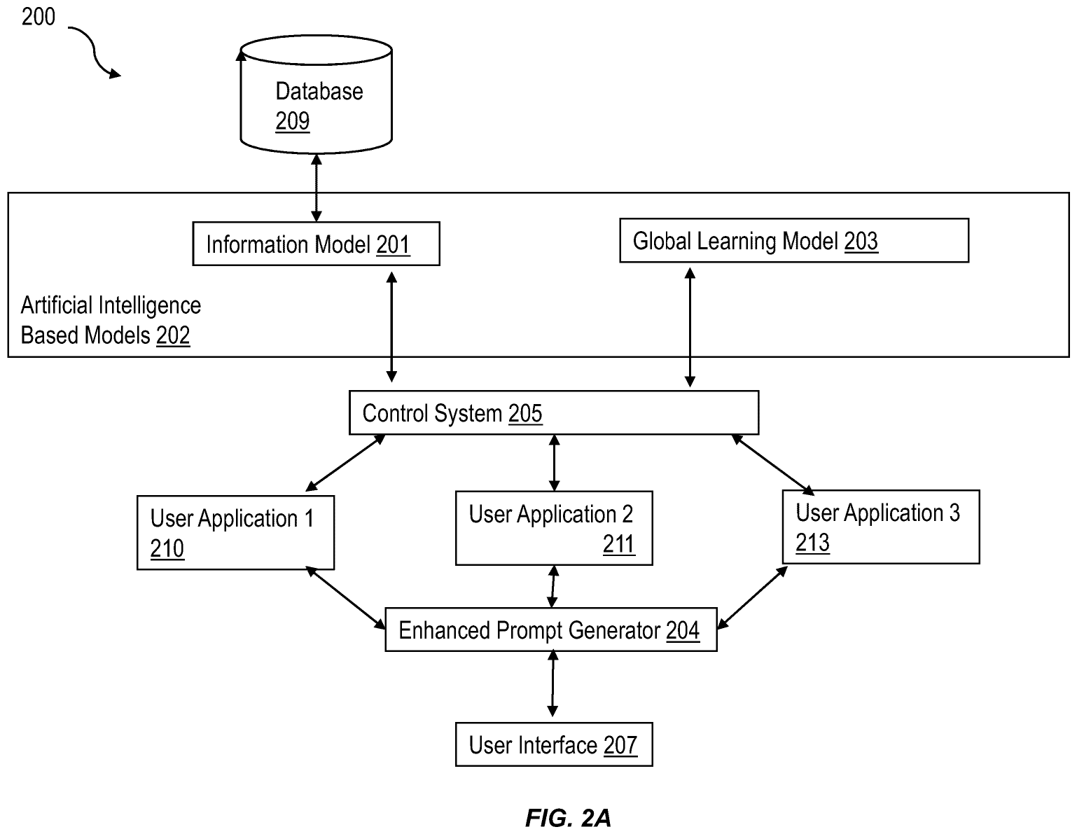

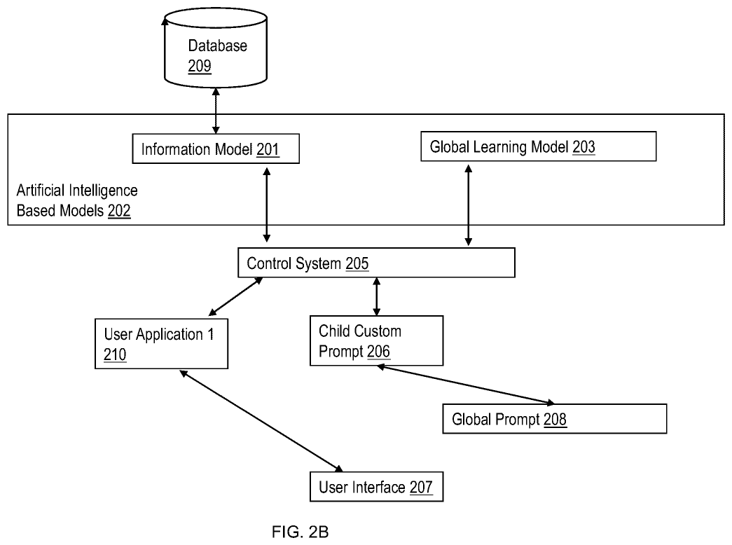

FIG. 2A is a system block diagram illustrating an example implementation of a system 200 for change-resistant and lincage-based prompt generation and distribution. For example, the system 200 may include artificial intelligence models 202, which may include information models 201, and/or foundational or global learning models 203. The artificial intelligence models 202 may be mediated by a control system 205. In some embodiments, the information model 201 may be communicatively coupled to a database 209 that includes enterprise specific data. The control system 205 may interface between the information model 201 and the foundational or global learning model 203. For example, the control system 205 may use the foundational or global learning model 203 to generate human comprehensible insights based on data and parameter sets provided by the information model 201. Additionally, the control system 205 may use the information model 201 to confirm the accuracy of output generated by the foundational or global learning model 203. Additionally, the control system 205 may use the information model 201 to access or edit information in the database 209. Additionally, the user interface 207 may be configured to allow inexpert users to confirm and accept the output of the combined system without requiring any data science expertise. The system 200 also includes an enhanced prompt generator 204 that is configured to provide enhanced queries to at least one of the control system 205, the global learning or foundational model 203, or the information model 201. In some embodiments, the enhanced prompt generator 204 generates change-resistant enhanced queries or prompts.

As shown in FIG. 2A, the enhanced prompt generator 204 can interface with one or more user applications 210, 211, or 213 that directly interact with the control system 205 and/or artificial intelligence based models 202. Examples of user applications 210, 211, 213 include, but are not limited to, document summarization applications, natural language queries, what's new analysis, analytics and the like. Accordingly, when an underlying artificial intelligence based model 202 is changed (e.g., settings for the model is modified, a new version of the model is deployed), the enhanced prompt generator may generate a modified enhanced prompt for each of the user applications linked to a template that uses the prompt.

FIG. 2B is a system block diagram illustrating a second example implementation of a system 200 for change-resistant and lineage-based prompt generation and distribution. As illustrated in FIG. 2B, artificial intelligence based models 202 can include information models 201 and global learning models 203. The artificial intelligence models 202 can be in communication with database 209. A control system 205 can be in communication with a user application 210 having a corresponding a customized child prompt 206. The customized child prompt 206 can be communicatively coupled to a global prompt 208.

In some embodiments, a user interacting with a user application 210 may provide the user application 210 with a query that is transmitted to the underlying control system 205. The underlying global learning model 203 can use the provided query to select appropriate data from the information model 201 and provide it to the control system 205. The control system 205 can then provide the information to the global learning model 203.

In this manner, the control system 205 can be configured for both retrieval and processing. For example, during retrieval the control system 205 can provide information to the global learning model 203, have the appropriate data retrieved from the informational model 201 and returned to the control system 205. In some embodiments, the data retrieved from the informational model 201 can be represented in tables, charts, or other structured data formats. During the processing aspect, the control system 205 may provide the data retrieved from the informational model 201 to the global learning model 203 for interpretation.

For example, in accordance with embodiments illustrated in FIG. 2B, a user provided query can state: “I am interested in sales are converted by lead source.” The underlying global learning model 203 can identify that the lead source is a channel. The corresponding data can be retrieved from the informational model based on the input from the global learning model. For example, all the data corresponding to the channel may be provided to the control system.

In some embodiments, when the global learning model 203 is updated, the global prompt 208 corresponding to the global learning model 203 is also updated. A corresponding child custom prompt 206 that is associated with the user application 210 can also be updated.

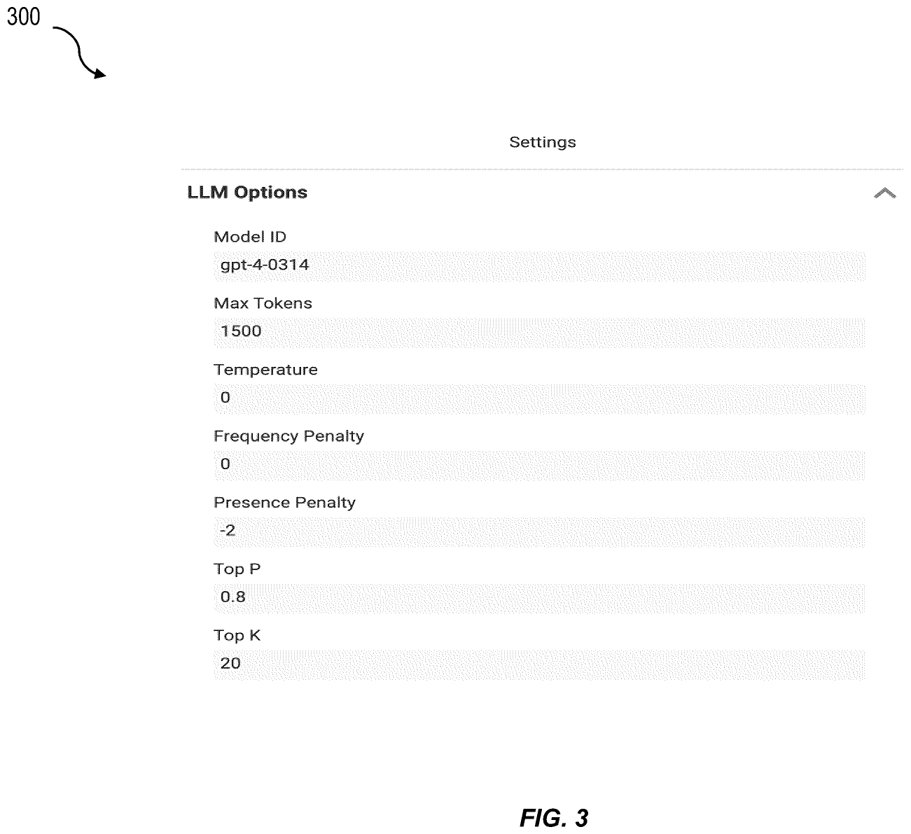

FIG. 3 provides an illustration of an interface 300 that shows settings of an artificial intelligence model that may impact the outcome or responses to a prompt received by the artificial intelligence model. As shown, the quality of the outcomes or responses to a prompt generated by a large language model may be affected based on the settings of the large language model including the temperature, frequency penalty, presence penalty, top p-value, and top k-value for the model. Settings for an artificial intelligence model may also include model parameters that provide guidelines for the output expected from the artificial intelligence model. For example, artificial intelligence models may be configured to generate responses or outputs that are more or less repeatable or creative, and/or have limitations or parameters on how often words or topics are repeated.

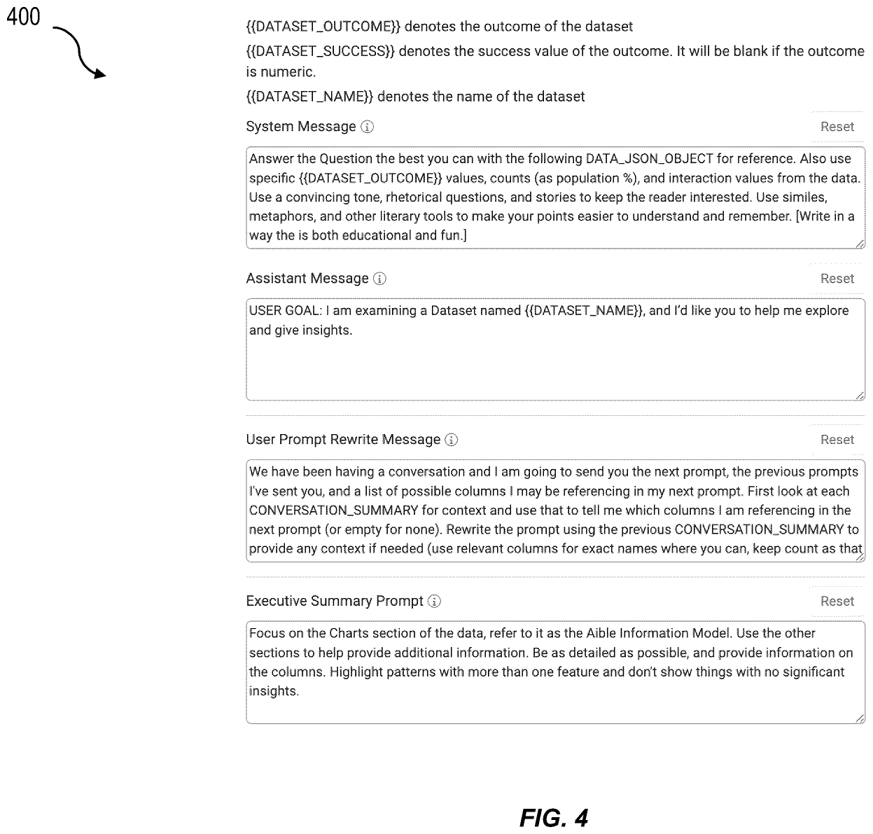

FIG. 4 provides an illustration of an interface 400 that shows enhanced prompts. As shown, a user may provide a generic prompt to an artificial intelligence system that is integrated with an enterprise. For example, the user may ask the system to explore a dataset. The enhanced prompt may provide a more robust set of instructions to the artificial intelligence based model. For example, the enhanced prompt may include the dataset object, indicate that the outcomes of the dataset need to be discussed, and parameters on how the response should be formulated. For example, parameters on how the response should be formulated may indicate a tone, cadence, narrative styles and the like that should be used in formulating the response. The enhanced prompt may also help reduce hallucinations via ‘grounding’ the artificial intelligence system to respond to the user prompt solely based on information in the provided dataset object.

In some implementations, user feedback to a response provided by the artificial intelligence based model can then be used to improve an artificial intelligence model or the prompt generator. In some embodiments, users can provide feedback to the system on which responses provided by the artificial intelligence model were the most relevant or responsive and which were not. Users can then edit the responses provided by the artificial intelligence model to a better response, which can then be saved and used as training data. User feedback, and training data generated by user feedback can be used for reinforcement learning, fine tuning, Low-Rank Adaptation of Large Language Models (LoRA), or other techniques for improving generative AI models. Some improvements may be based at least in part on the enhanced prompts provided to the artificial intelligence model. As shown the user is provided with an option of editing and saving the response of an artificial intelligence model as training data.

In some implementations a user may be able to view and adjust the modified enhanced prompts, prior to it being provided to the artificial intelligence based model. For example, a user may be able to provide feedback as to whether the proposed modification to the enhanced prompt meets a requirements set by the user. In some implementations the adjustments to the enhanced prompts made by the users can be saved in the form of templates and propagated throughout all user applications in the lineage of that template in order to make global systemic changes to the enhanced prompts. A user may view modified enhanced prompts in a graphical user interface and provide feedback to the modified enhanced prompts by entering text in a textbox, selecting icons on the user interface, adjusting parameter values and the like.

In some implementations, positive feedback from a user that a modified enhanced prompt generated better outputs from the artificial intelligence based model can be used to determine whether the modified enhanced prompt can be used as training data for the generation of additional prompts. In some implementations, users can also provide few shot feedback. Few shot learning is a machine learning framework in which an AI model learns to make predictions by training on a very small number of labeled examples. It can be used, for example, to train models for classification tasks when suitable training data is scarce. Positive and/or negative feedback can be provided by the user by selecting icons indicating when a modified enhanced prompt generated better (e.g., thumbs-up) or worse (e.g., thumbs-down) outputs, providing ratings (e.g., selecting a sliding scale value or selecting a number on a screen) and the like.

Few shot feedback can include providing the underlying artificial intelligence model with additional information such as an example of prior prompts, queries, and responses that the user indicates as being responsive. For example, the artificial intelligence model underlying the application can be provided with a template that is linked to a parent and receive specific instructions that augment the user experience. For example, the specific instructions can include one or more examples of past queries and responses that the user found responsive. Accordingly, the provided responses can serve as examples for the underlying model. In some embodiments, the user may provide feedback on the responses generated by the system. Feedback may be in the form of an input to the graphical user interface. For example, a user may click on a thumbs-up or thumbs-down icon positioned adjacent to the provided response to indicate that a response was “good” or highly relevant, or “bad” or less relevant. In some embodiments, user feedback can be incorporated into retraining one or more prompt generators and/or underlying artificial intelligence models.

In some implementations users can have customized and individualized experiences using different chat tones or supplemental instructions. For example, users can customize interactions through a user application that uses a template beyond the base templates provided by the enhanced prompt generator. In some implementations, user customizations can be monitored to determine whether additional modifications of the base template are needed. For example, a setting such as temperature vectors, size, and count can be monitored.

In some implementations, users may have customized components for the conversations. For example, a user can be associated with a chat tone that adjusts how the language model responds. For example, the chat tone can indicate that a provided response should be in narrative format, as a bullet point list, provide a story, use metaphors, asking rhetorical question, to the point, and the like. The user can specify the components of the response they receive, the quantity of responses, types of retrievals and the like. The system can monitor user settings and determine if user settings are optimized for responses. In some embodiments, optimized settings can be applied all users. In this manner best practices for prompt generation can be applied throughout the population of users.

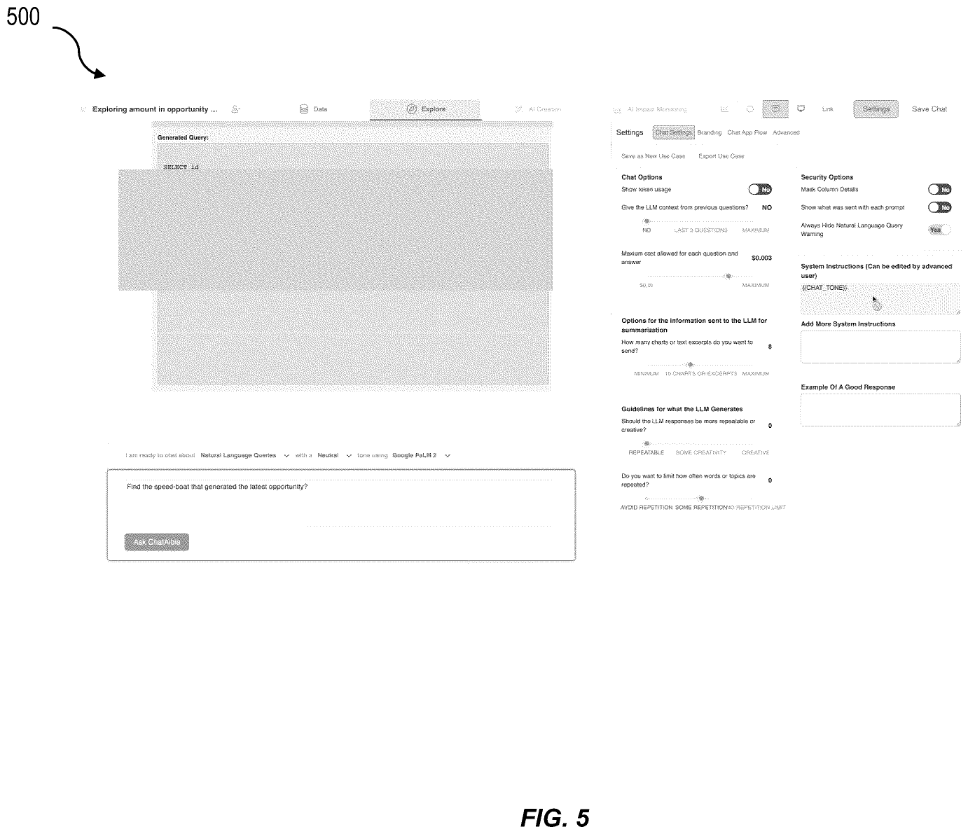

FIG. 5 provides an illustration of a user interface 500. As illustrated, a user may enter a natural language based query, and designate settings (e.g., queries, neutral tone, AI-model). The interface may generate system instructions based on a template, and generate and display an enhanced query (i.e., generated query). The enhanced query can be modified based on adjustments to the system instructions, or by receiving an indication that the underlying AI model has been updated.

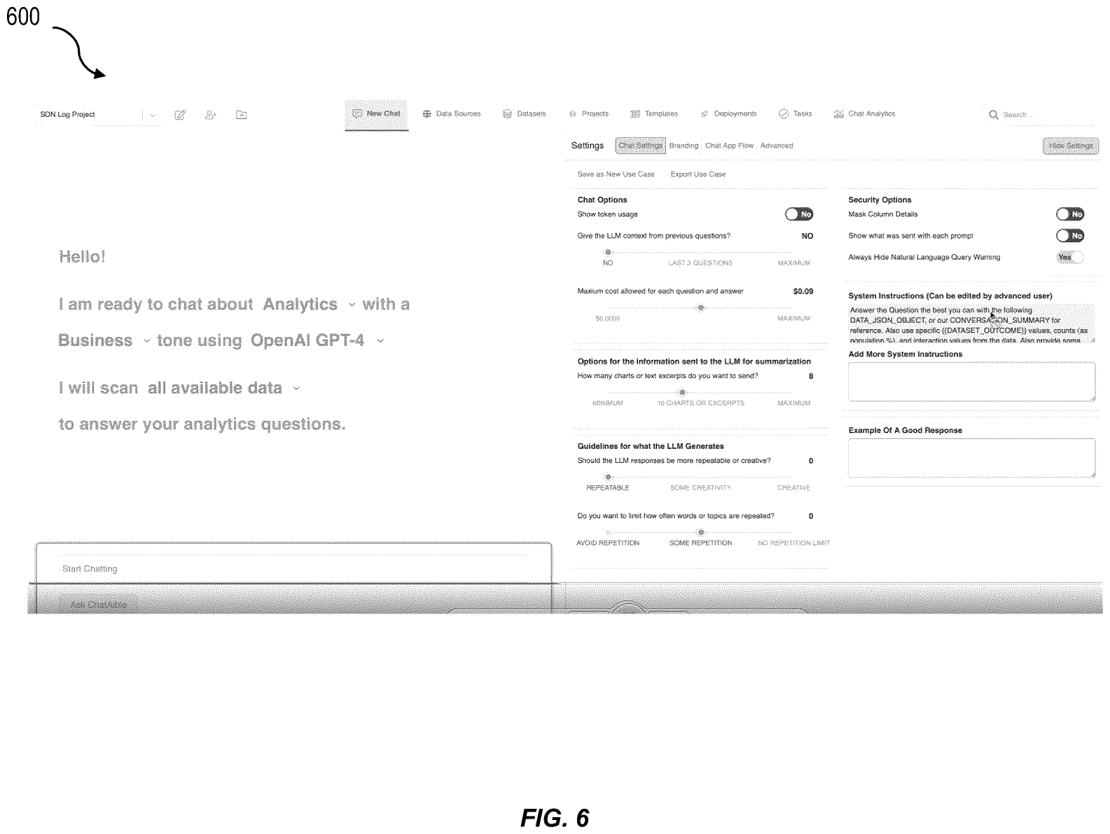

FIG. 6 provides an illustration of a user interface 600. As shown the system instructions can include template data that is used to interface with the underlying artificial intelligence model.

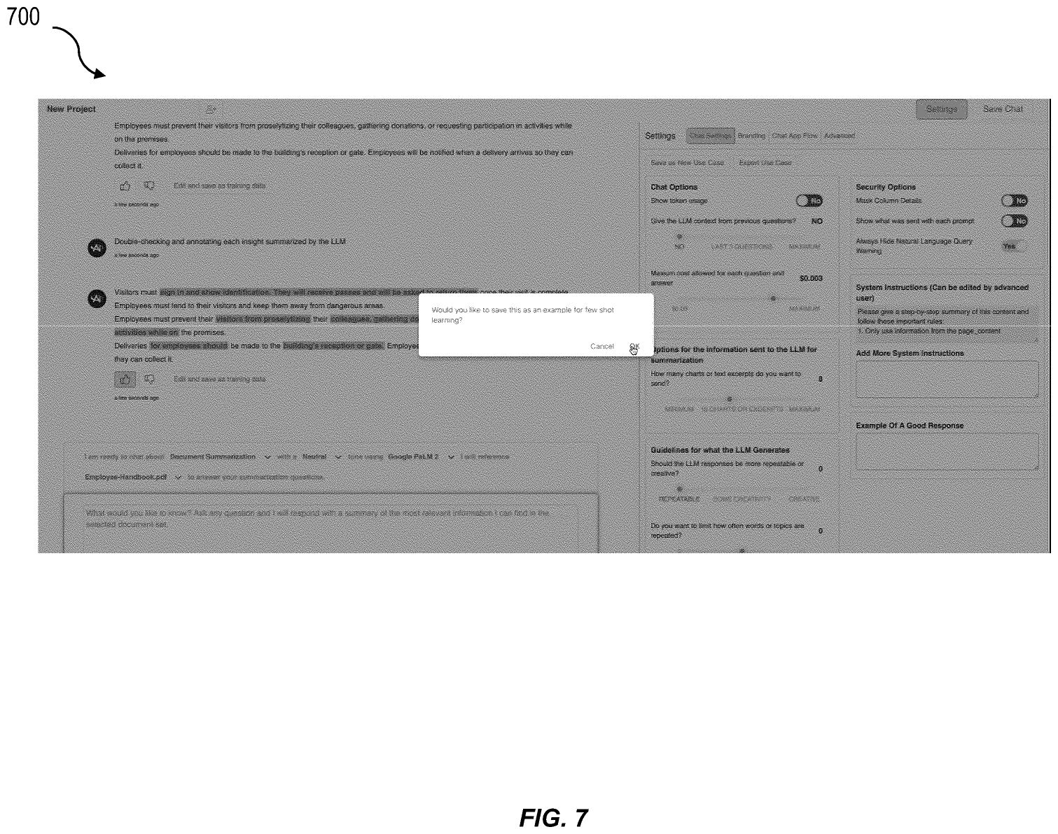

FIG. 7 provides an illustration of a user interface 700. As shown the user interface 700 can provide a user with a response. A user can then indicate if it is a “good” or “bad” response by selection of thumbs-up/down icons. The user can then elect for the response to be saved as a good response used to train the prompt generator and/or the underlying AI model using few shot learning.

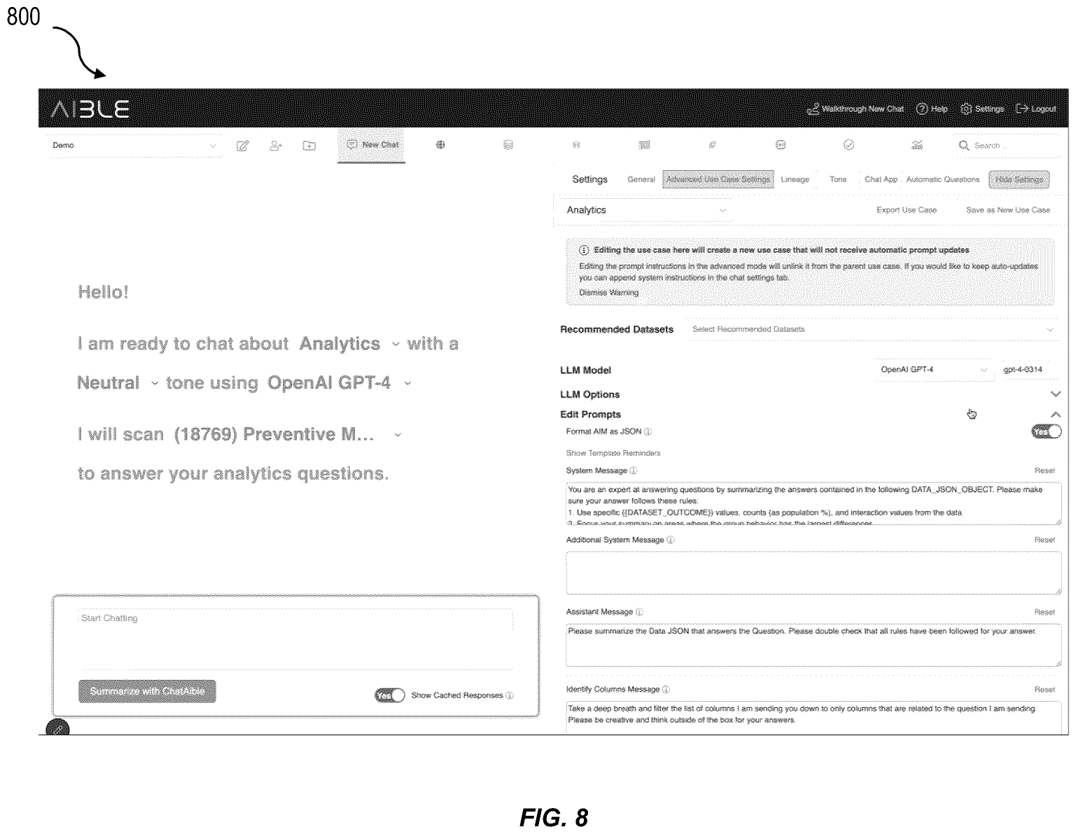

FIG. 8 provides an illustration of a user interface 800. As illustrated an advanced use case settings tab may provide a portion of the graphical user interface 800 to a user that allows for a user to make edits to a prompt template. In this manner a user can edit and provide the controller with instructions for a child template for use with a user application.

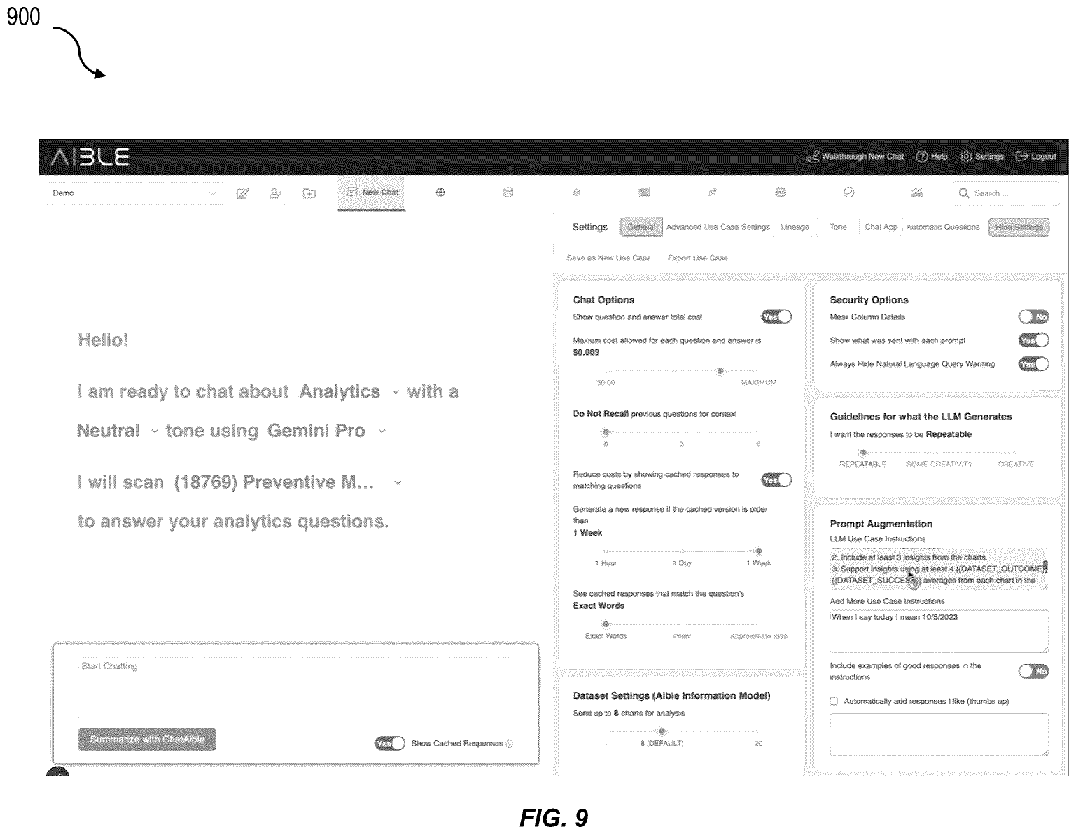

FIG. 9 provides an illustration of a user interface 900. As illustrated, a user can input data indicative of their preferences for a chat tone, or how they would like the global learning model to respond to the user. For example, the user can provide chat options such as the maximum cost allowed for each question and answer, an indicator as to whether the global model should recall previous questions for context, how cached responses should be used, data set settings for the informational model (e.g., how much data is retrieved), guidelines for the global model, security options, and preferences for how a prompt can be augmented. As shown in FIG. 9, in some embodiments, the user may select examples of good responses to be provided in the instructions provided to the global model.

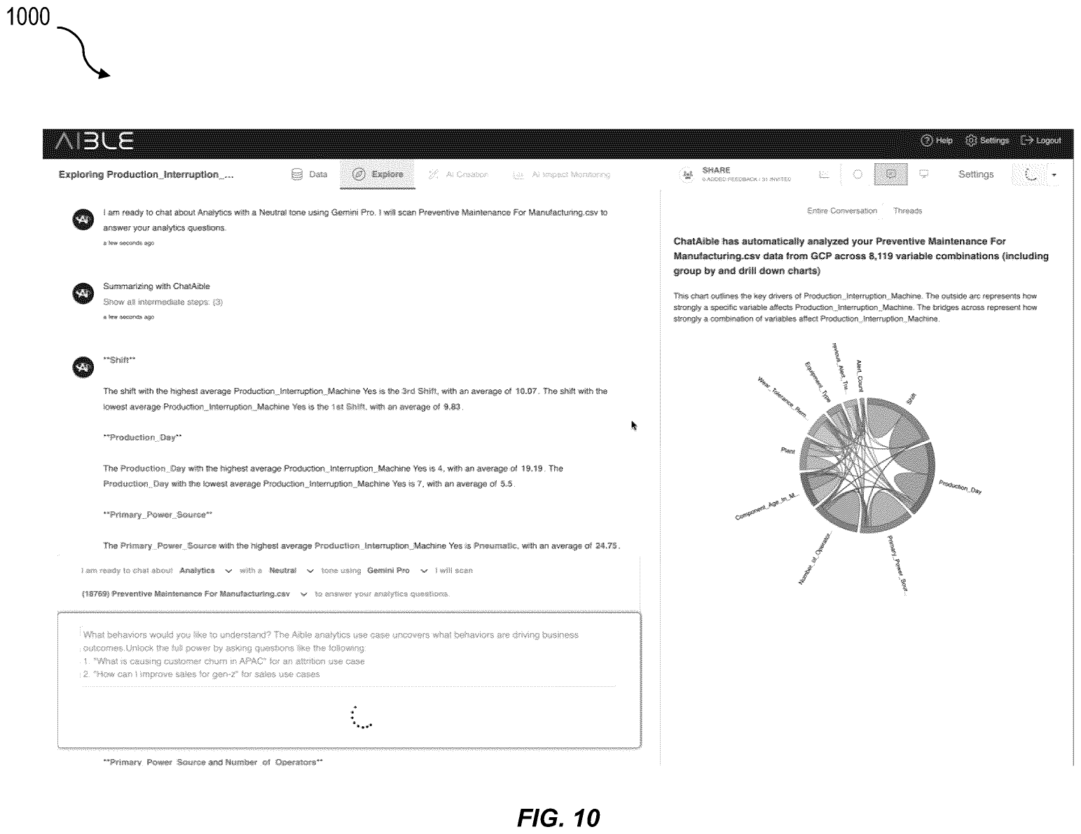

FIG. 10 provides an illustration of a user interface 1000. As illustrated in FIG. 10 in some embodiments, the system may provide a response in a conversational format. As shown in FIG. 10, data from an enterprise related informational model can be summarized using a global model and provided to a user in a conversational format. In some embodiments, graphical charts and summarizations can also be provided to a user. A user can also use drop down menus to select a chat tone. For example, a user can select that they want to chat about a subject matter (e.g., Analytics) with a particular tone (e.g., Neutral) using a particular underlying global model (e.g., Gemini Pro). The user can also specify data from an informational model to use such as a particular data file.

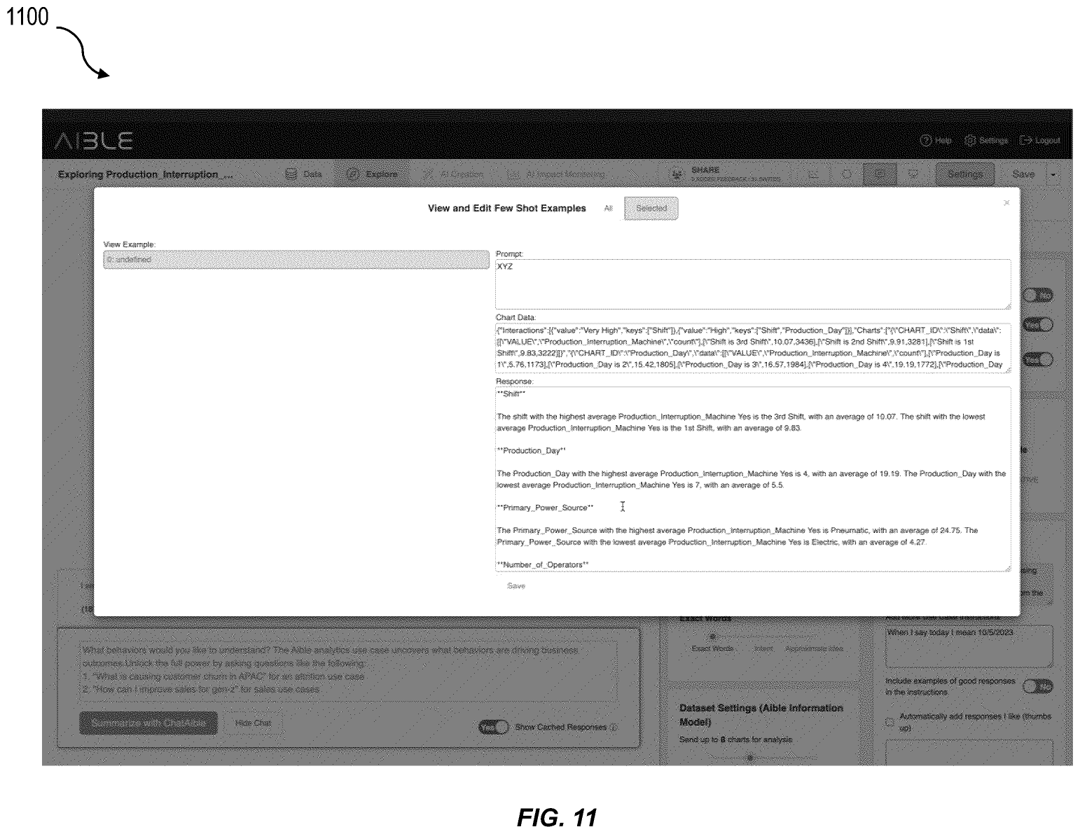

FIG. 11 provides an illustration of a user interface 1100. As illustrated in FIG. 11, in some embodiments, the graphical user interface 1100 may allow for the viewing and editing of few shot examples. For example, in some embodiments the system may generate a historical listing of prior prompts alongside their corresponding data retrieved from the informational model and generated response. A user can then view and edit the prior historical listings based on whether they produced responses that were relevant to the user's query.

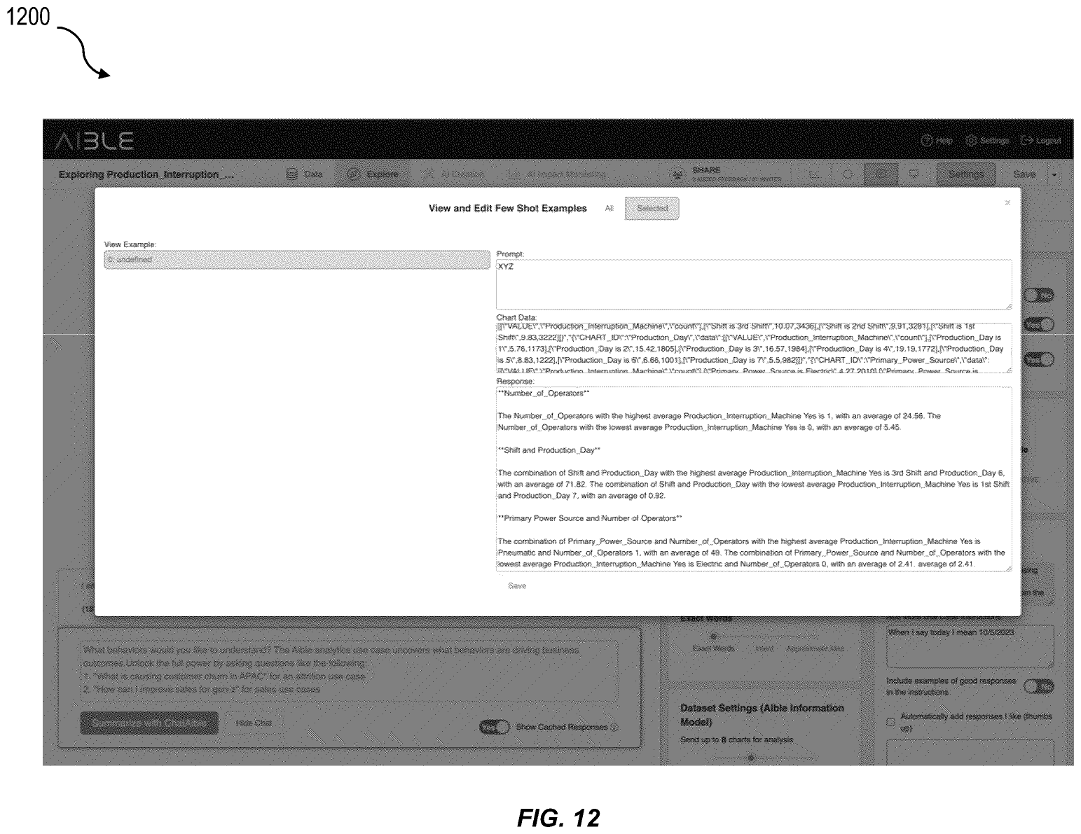

FIG. 12 provides an illustration of a user interface 1200, where the user has edited the few shot examples. As illustrated, the user can view the provided prompt, data from the informational model (e.g., chart data) that is provided to the global model, alongside the response produced by the global model. In some embodiments, these few shot examples can then be provided to the model for improved responses.

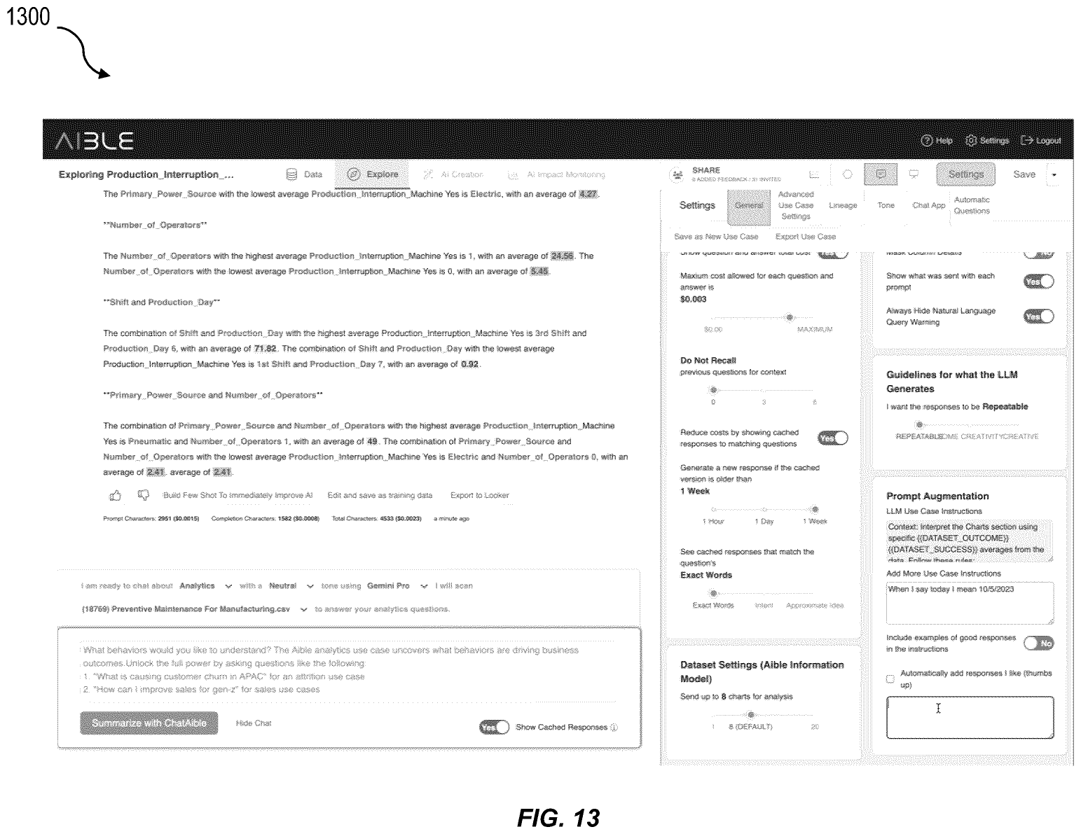

FIG. 13 provides an illustration of how a user can explore the responses that are provided by the global model in a graphical user interface 1300. For example, as shown the user can select various provided data or metrics and receive identification of what underlying data corresponds to the provided response. Additionally, the user can provide feedback via the user interface, for example by selecting a thumbs up or thumbs down to indicate whether the provided response is responsive to the user's query. The user can also indicate that they wish to incorporate the provided responses as a few shot entry to improve the underlying model, for example, by selecting the “build few shot to immediately improve AI” icon. Additionally, or alternatively the user can edit and save the provided response as training data for one or both of the informational model, or global model. The user can also export the response to a “looker” or other area to explore the underlying data corresponding to the provided response.

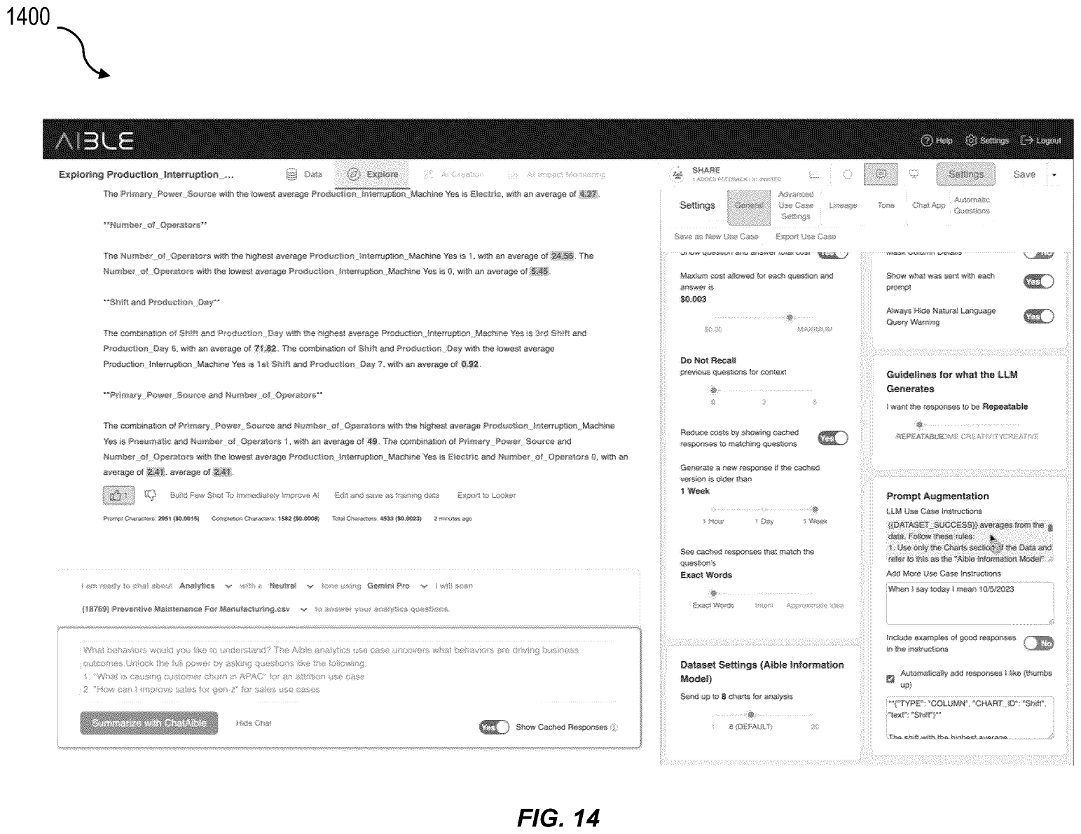

FIG. 14 provides an illustration of the graphical user interface 1400 and how to receive user feedback. As shown, the user can select an icon to indicate that the response was relevant, e.g., by selecting a thumbs-up icon.

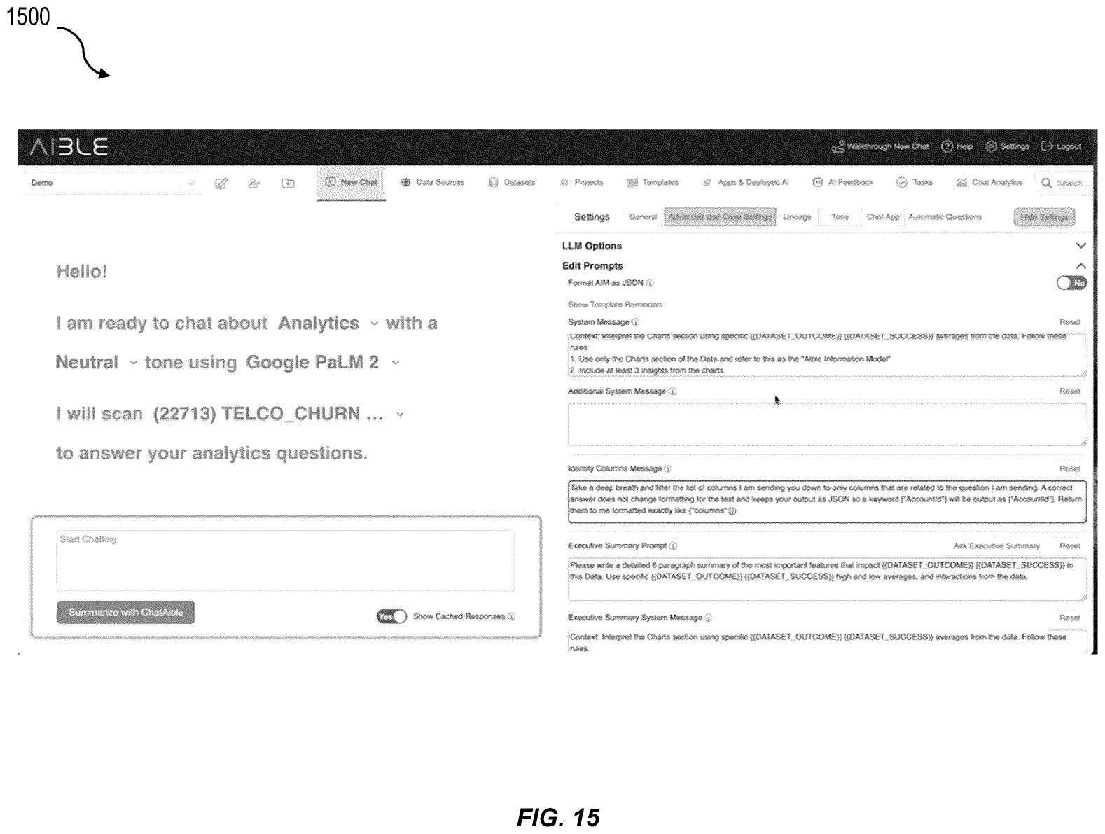

FIG. 15 provides an illustration of the graphical user interface 1500. As shown, the user may select an advanced use case setting. Upon selecting the advanced use case setting the user may edit global prompts in a template. For example, the user can provide the global learning model with instructions and prompts. The global prompts can be propagated to child prompts.

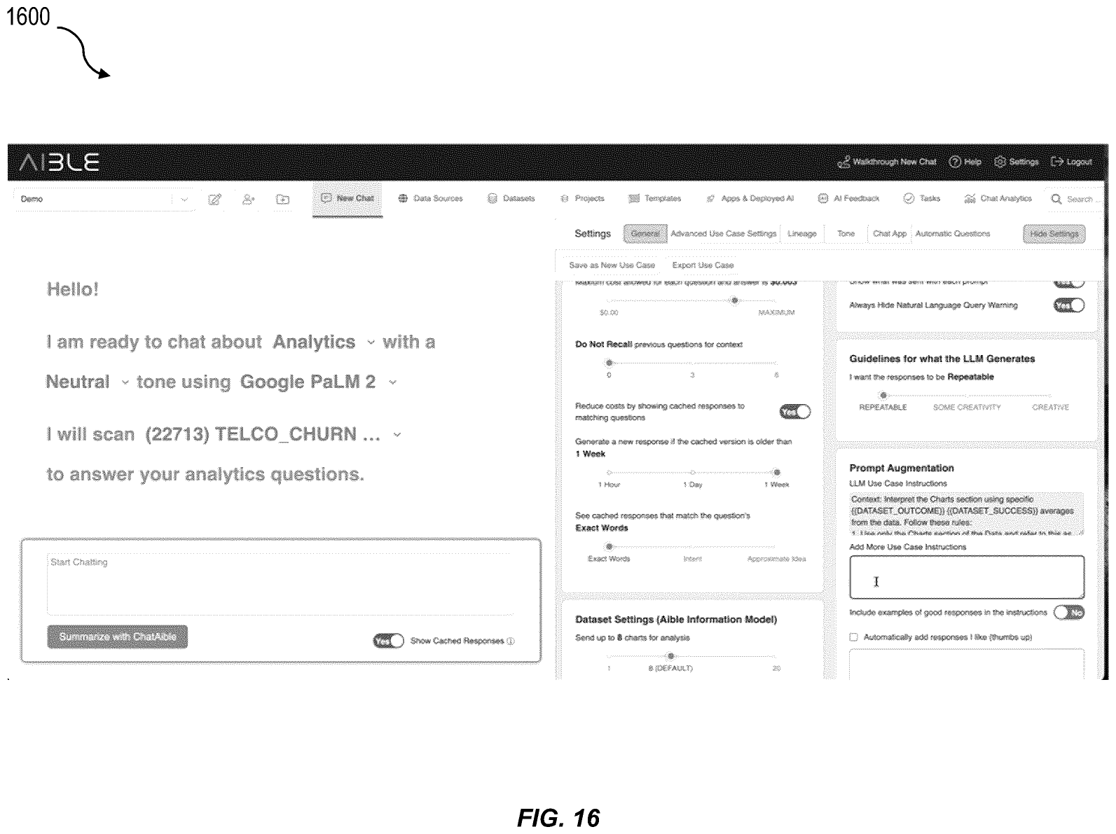

FIG. 16 provides an illustration of the graphical user interface 1600. As shown, the user may use the graphical user interface 1600 for prompt augmentation. For examples, using a prompt augmentation portion of the graphical user interface users can enter definitions that provide usage notes to the underlying model.

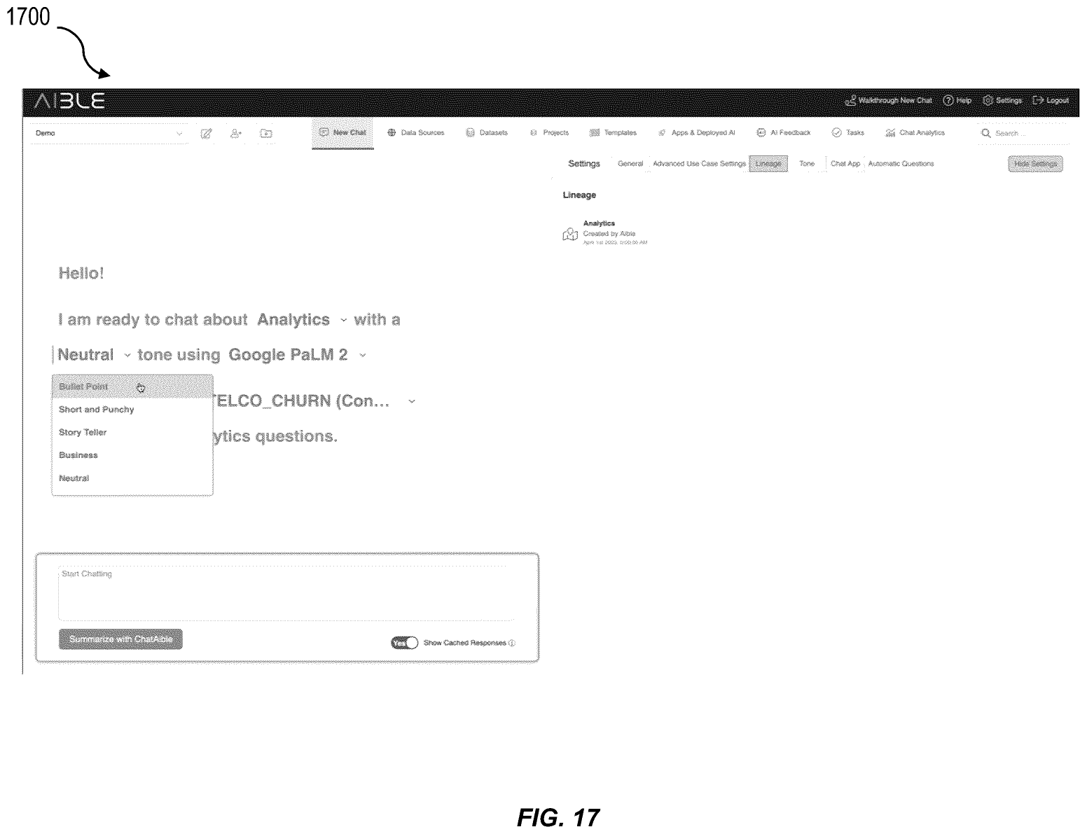

FIG. 17 provides an illustration of the graphical user interface 1700 in which a user can provide input as to the chat tone that they prefer to receive a response in. Examples of chat tones can include neutral, bullet point, short and punchy, story teller, business, and the like. Selection of a chat tone can be facilitated by a drop down menu and selection. The graphical user interface 1700 can also provide a display of analytics and related lineage. For example, lineage information can display parent and children prompts.

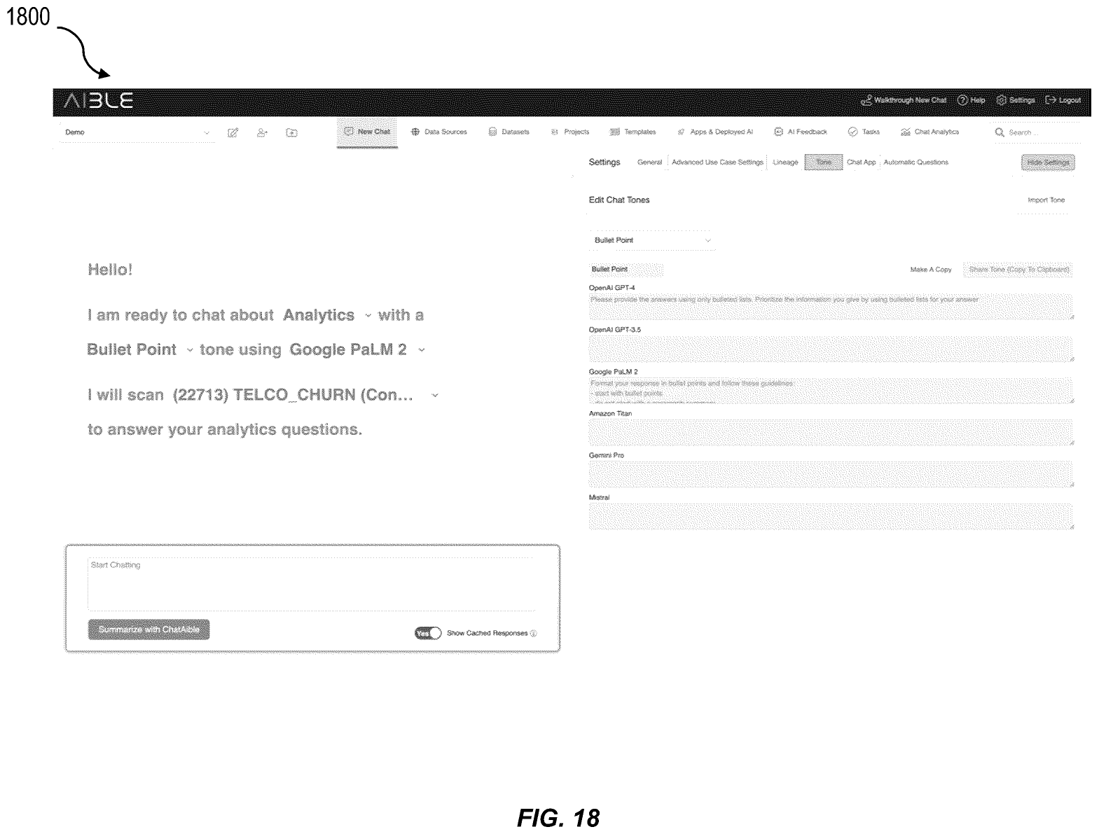

FIG. 18 provides an illustration of the graphical user interface 1800 in which a user is able to provide input as to the chat tone that the response from the global learning model will be provided in. For example, a user can designate that a “bullet point” tone and an appropriate prompt can be generated for each underlying global model (e.g., OpenAI GPT-4, OpenAI GPT3.5, Google PaLM 2, Amazon Tital, Gemini Pro, Mistral, and the like). As illustrated in FIG. 18, in some embodiments, a user input indicating a “bullet point” chat tone can correspond to a first prompt for a first global learning model (e.g., “please provide the answers using only bulleted lists”) while the same user input can correspond to a different prompt for a second global learning model (e.g., “Format your response in bullet points and following these guidelines: —start with bullet points”).

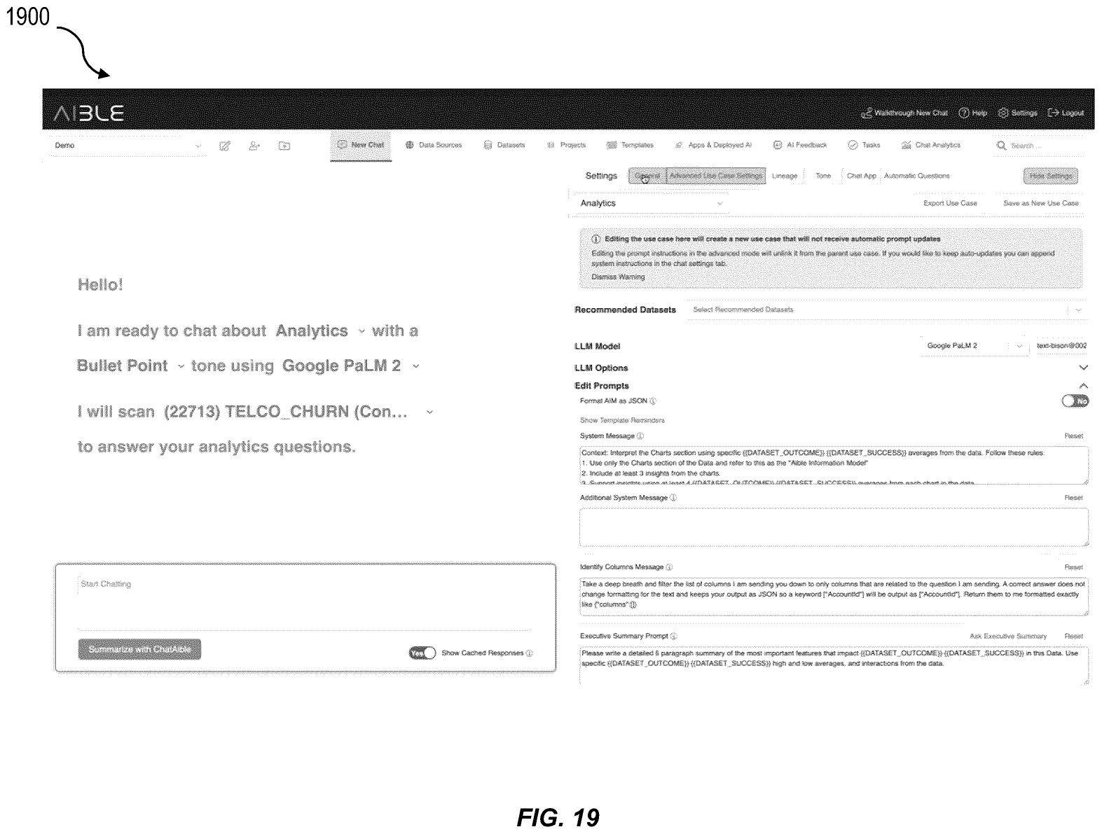

FIG. 19 provides an illustration of the graphical user interface 1900 in which a user is able to provide input. Examples of inputs provided by the user include creating new use cases that would not receive automatic prompt updates. For example, as illustrated in FIG. 19, in some embodiments, a child or downstream prompt can be edited in an advanced mode of the system. While the prompt settings were initially set by a global or parent prompt, the downstream child prompt can be edited. The resulting edits may not be propagated to the parent prompt. The user can select whether they wish to have the downstream child prompts remain linked to the upstream parent prompts.

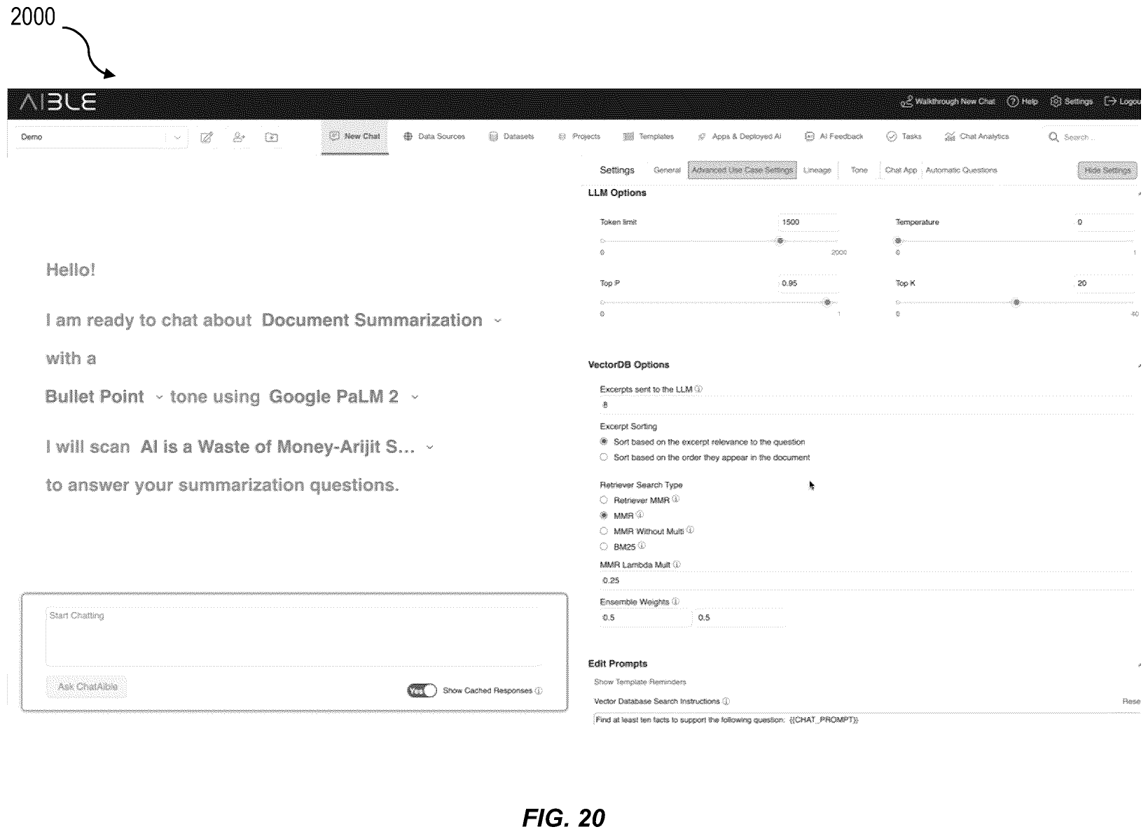

FIG. 20 provides an example of a graphical user interface 2000 that allows a user to visualize data corresponding to a vector database of a global model, informational model, and the like. In some embodiments, the user can specify data from the informational model represented in a vector database for selection and for providing to a global model.

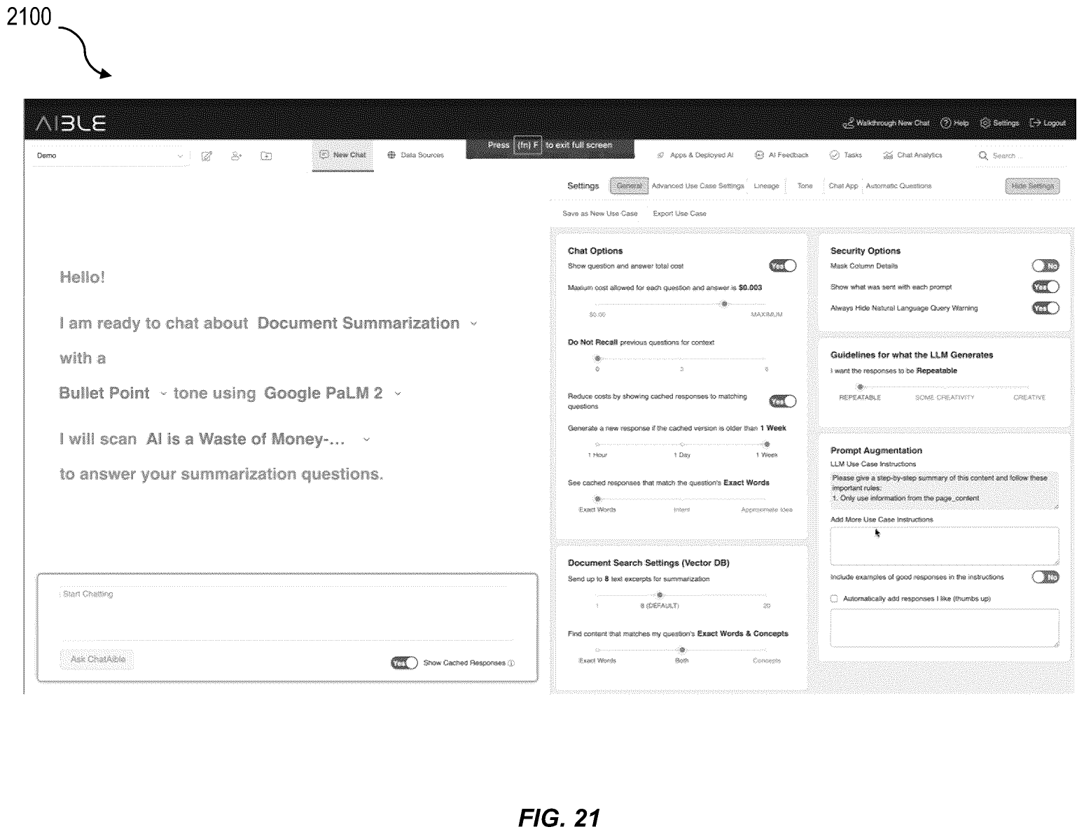

FIG. 21 provides an example of a graphical user interface 2100 that allows a user to input one or more of: chat options, document search settings for the vector database, security options, guidelines for the global model, and prompt augmentation settings. For example, as shown in FIG. 21, in some embodiments, the user may provide specific instructions for inclusion when querying the global model. Further, as shown in FIG. 21, the document search settings can include querying a vector database and user input specifying how to find context that matches a user prompt's exact words and concepts.

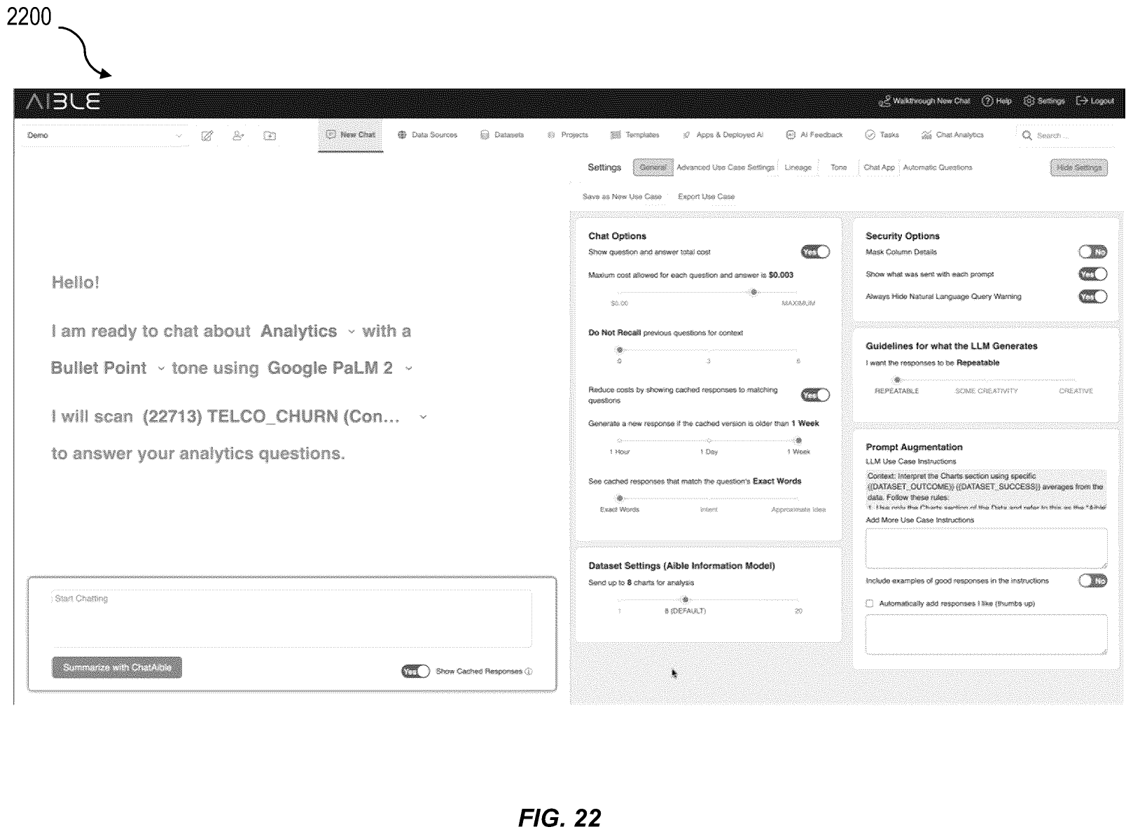

FIG. 22 provides an example of a graphical user interface 2200 in which a user can adjust the settings used for the informational model. For example, the user can specify the number of datasets or charts retrieved by the informational model (and later provided to the global model). Although a few variations have been described in detail above, other modifications or additions are possible. In some embodiments the global learning model can utilize graph models and graph databases for use in summarizing data. For example, users can ask both concept based and exact questions. In some implementations, a user can ask association questions that an rely upon a graph database to produce answers. In some implementations, the informational model is a retrieval analytics based augmented model. In some implementations, the systems can include a “what's changed” analysis, which identifies and assesses the effects of change on the model.

The subject matter described herein provides many technical advantages. In some embodiments, the disclosed systems can be used for retrieval-augmented generation analytics, which can be used to enhance the accuracy and reliability of document summarization provided by the global learning model with facts and data retrieved from external sources. As opposed to using a cloud-based server vector database, some implementations of the disclosed systems can be implemented in a serverless vector database, providing economical and data storage efficiencies for the user.

As discussed above, in some embodiments, user applications that interface with AI-based models can be improved using improved selection of parameter settings. Because the selection of prompts and/or parameter settings may moderate interactions between the user application and the underlying AI-based model, improved prompts, learning and selection of parameter settings may result in a user application or platform receiving improved outputs from AI-based models that face challenges in producing salient, relevant and efficient outputs in shorter timespans in response to user-generated prompts. Indeed, the quality of the output generated by the AI-based models can vary greatly based on the user provided prompt to the artificial intelligence system, the selection of the artificial intelligence systems itself, and settings of the artificial intelligence system.

For example, the quality of the output produced by an AI based system can vary based on settings. Settings can refer to the type of AI-model selected, the required saliency, relevancy, context, computational time required to generate a response, chat tones, and the like. Some implementations of the disclosed systems and methods can provide a system that illustrates the performance of one or a plurality of models over time. In some embodiments, the disclosed systems and methods can be configured to allow user input of settings and parameters indicative of design choices for the AI-model and provide a visual indication of a performance of a particular AI-model in view of the selected user input of settings and parameters. Accordingly, the system may provide the user with a view of multiple AI-models and their respective settings and allow a user to provide design choices for a selected AI-model.

In some aspects, artificial intelligence based systems can be evaluated based on their ability to meet an underlying objective for an AI system such as a cost efficiency metric (e.g., a valuation of the cost for generating a model in comparison with the benefits provided by the model). For example, different applications, such as different chat applications can be evaluated to determine if there is a particular model, prompt, and/or chat tone that provides an improved response for a particular application. In some aspects, user feedback data related to different applications that utilize different models and/or parameter settings can be used to train one or more artificial intelligence based systems. In some aspects, the performance of different models and/or parameter settings can be monitored and used to provide improved applications to a user.

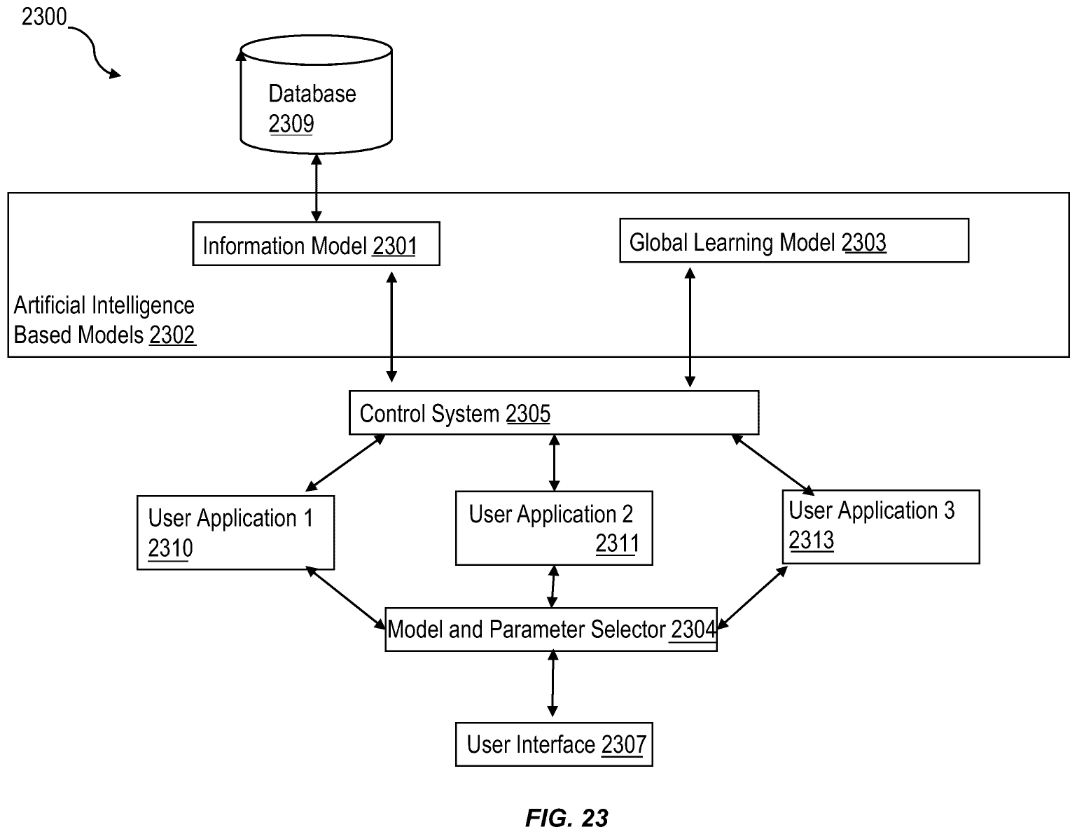

FIG. 23 is a system block diagram illustrating an example implementation of a system 2300 for improved applications utilizing artificial intelligence models. For example, the system 2300 may include artificial intelligence models 2302, which may include information models 2301, and/or frontier, foundational or global learning models 2303. The artificial intelligence models 2302 may be mediated by a control system 2305.

In some embodiments, the information model 2301 may be communicatively coupled to a database 2309 that includes enterprise specific data. The control system 2305 may interface between the information model 2301 and the foundational or global learning model 2303. For example, the control system 2305 may use the foundational or global learning model 2303 to generate human comprehensible insights based on data and parameter sets provided by the information model 2301. Additionally, the control system 2305 may use the information model 2301 to confirm the accuracy of output generated by the foundational or global learning model 2303. Additionally, the control system 2305 may use the information model 2301 to access or edit information in the database 2309. Additionally, the user interface 2307 may be configured to allow inexpert users to confirm and accept the output of the combined system without requiring any data science expertise. The system 2300 also includes a model and parameter selector 2304 that is configured to assist an application is determining one or more model and/or parameter settings. As shown in FIG. 23, the model and parameter selector 2304 can interface with one or more user applications 2310, 2311, or 2313 that directly interact with the control system 2305 and/or artificial intelligence based models 2302. Examples of user applications 2310, 2311, 2313 include, but are not limited to, document summarization applications, natural language queries, what's new analysis, analytics, chat applications, and the like.

In some embodiments, a system built in accordance with those described in FIG. 23, can include an informational model that includes customized retrieval augmentation generation for extraction of analytics information from structured data sets. In some embodiments, the analytics information can be for a business objective, or include proprietary data. Additionally, an informational model such as 2301 can be configured to generate natural language queries in the form of a SQL statement and the like that can be used for retrieval augmentation for queries sent to a language model such as a foundational or global learning model 2303 for a response. Additionally, in some embodiments, the informational model can include one or more specialized templates that are compatible with semi-structured data. Accordingly, unstructured text can be retrieved by filtering through different structured fields. In this manner, a combined vector database can be utilized more efficiently with full, unstructured capability.

In some embodiments, a user application that is configured to generate a response to a query provided by a user can include a multi-step process. In a first step, information may be retrieved from an informational model such as 2301 using a language model, deterministic system, vector database and the like. In a second step, the retrieved information can be provided to a global model that can include a language model. A user application can include various settings for both the retrieval of information in the first step, and the interactions with the global model in the second step.

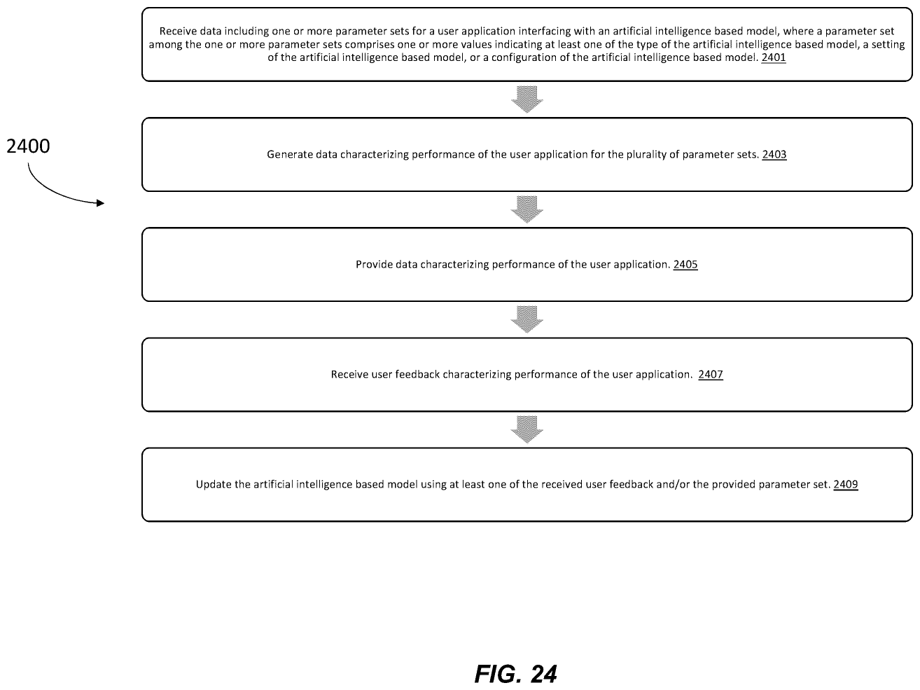

FIG. 24 provides a block-diagram illustrating a process 2400 for improving applications that interface with artificial intelligence based models. As illustrated, in a first step 2401, data including one or more parameter sets for a user application interfacing with an artificial intelligence based model can be received. In a second step 2403, data characterizing performance of the user application for the plurality of parameter sets can be generated. For example, the data characterizing performance of the user application can include evaluations of the output from the underlying artificial intelligence model for each of the plurality of parameter sets. In a third step 2405, the data characterizing performance of the user application can be provided. In a fourth step 2407, user feedback characterizing performance of the user application can be received. In a fifth step 2409, the artificial intelligence based model can be updated using at least one of the received user feedback and/or the provided parameter set.

As discussed herein, a parameter set can include one or more values indicating at least one of the type of the artificial intelligence based model, a setting of the artificial intelligence based model, or a configuration of the artificial intelligence based model. For example, a parameter set can indicate the type of AI model (e.g., Gemini, Chat GPT, etc.). The parameter set can also include one or more values indicating a setting such as a conversational tone or the like. Based on the provided parameter set the user application utilizing the artificial intelligence model can be run. The performance of the user application can then be determined based on one or more performance metrics. Performance metrics can include run time, quality metrics of responses generated for a prompt provided to the artificial intelligence model, processing power required for the generation of the response by the artificial intelligence model, and the like.

In some embodiments, the method can receive user feedback characterizing performance of the user application. For example, a user may provide feedback by interacting with a graphical user interface. For example, a user can indicate if the response provided by the artificial intelligence model is good, bad, or neutral. A user can provide their feedback by selecting one or more graphical icons, or by ranking the performance of a plurality of models and the like. In some aspects, user feedback may provide an indication as to responses that are more salient or responsive in the context of an enterprise.

In some aspects, a model and parameter selector that can view parameter sets, and responses generated by a plurality of user applications and/or underlying artificial intelligence models can determine a combination of parameter sets and/or underlying artificial intelligence models that are receiving more favorable feedback from users. In this manner the model and parameter selector can determine which combinations of models and/or parameter sets are providing responses that are favored by a user. In some aspects the model and parameter selector can weigh user feedback along with one or more costs or expenditures related to a particular combination of the artificial intelligence model or selected parameter. As discussed above, costs and expenditures can include monetary costs associated with the enterprise related to running an artificial intelligence model (e.g., overhead, electricity, purchasing of computing power), run time, processing power requirements, speed, and the like.

In some aspects, the method can be further configured to update one or more applications to use a particular artificial intelligence model and corresponding parameter setting based on the received user feedback and/or the provided parameter set. In some embodiments, the artificial intelligence based model can be updated or retrained using the received user feedback and/or the provided parameter set. In some embodiments, the model and parameter selector 2304 can determine a set of models and/or parameters to use in a particular context. A context may refer to the end objective of the response, constraints on one or more parameters in the parameter set, and acceptable resources for generating a response. The model and parameter selector 2304 can also be used to determine one or more combinations of models and parameter sets that are expected to receive more positive feedback from end users. Accordingly, the discussed system can be used to enhance the relative experience provided to a user and improve user satisfaction.

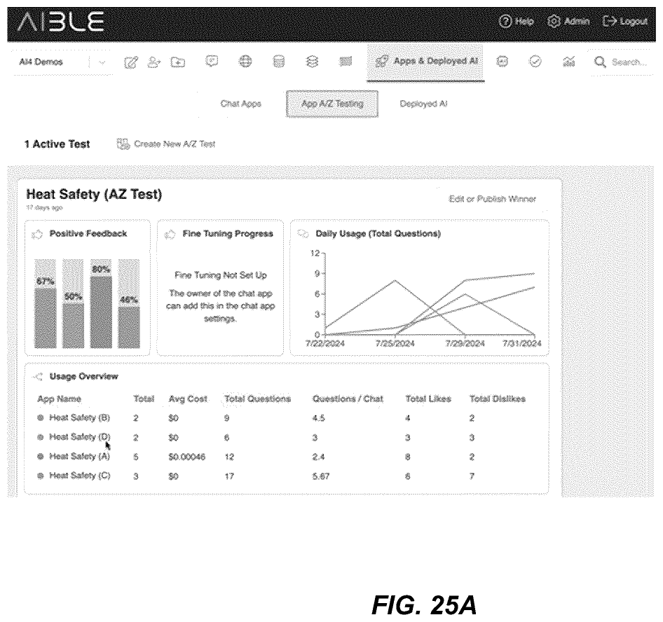

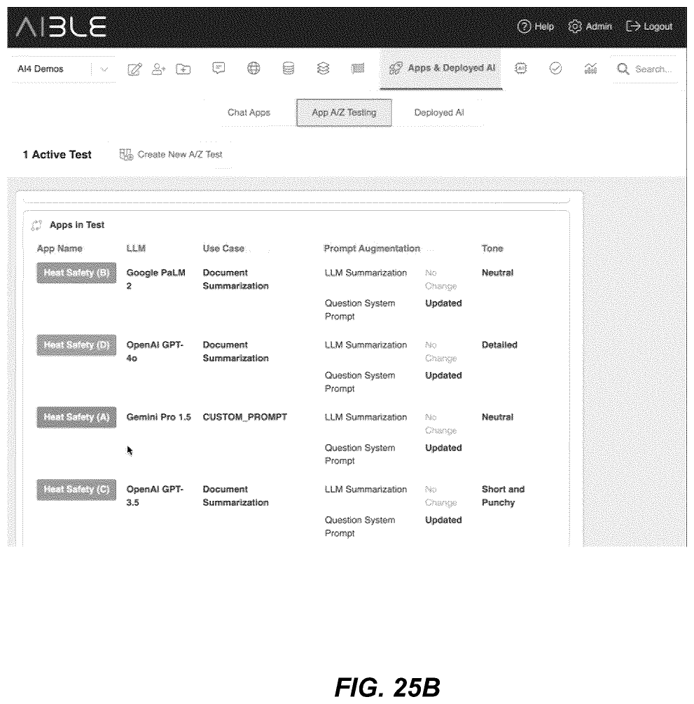

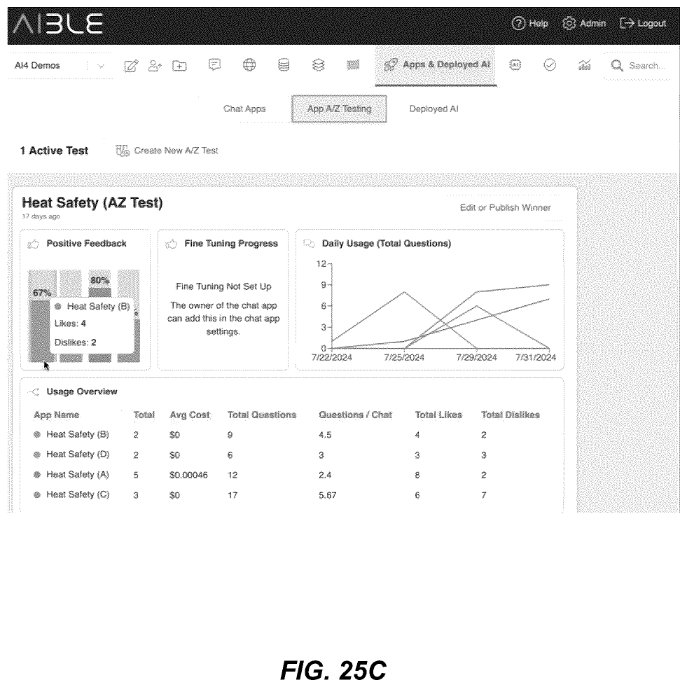

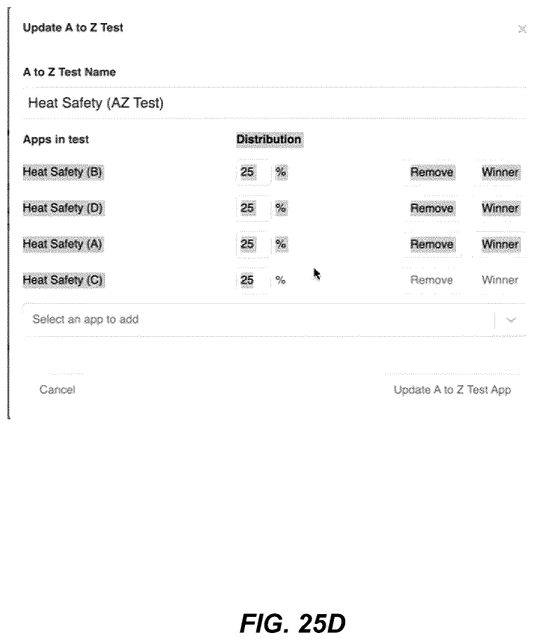

FIG. 25A provides an illustration of a user interface for a model and parameter selector, such as model and parameter selector 2304. As shown in FIG. 25A a user interface for A to Z testing 2500 can illustrate the performance of multiple user applications, analogous to user applications 2310, 2311, or 2313. As illustrated, user applications can have one or more individualized settings that are indicative of source information, language models, customizations as to the language models, prompt engineering customizations, tone customizations and the like. For example, a user application may include an implementation for a retrieval augmented generation process.

The user interface for A to Z testing 2500 can be used to evaluate the performance of the user applications. Additionally, the user interface for A to Z testing can receive and display user feedback regarding the performance of the user application. In some embodiments, performance can be measured objectively (e.g., whether a factually correct response was provided by the language model), or subjectively (e.g., whether a user provided feedback indicating the response was “good” or “bad” or “neutral”). The user interface for A to Z testing can provide developers and other users the ability to evaluate the performance of multiple user applications. For example, the overall performance may take into account both objective and subjective factors, including for example, the operating cost, and the response time of the models interfacing with the user application. The overall performance may be a weighting that includes a measure of the importance associated with the task being performed by the user application. For example, for a task requiring high precision and accuracy, a slower, expensive user application that provides accurate performance 95% of the time can be favored over a faster, less expensive user application that provides accurate performance 85% of the time.

FIG. 25A provides a user interface for A to Z testing 2500. As shown, an A to Z testing interface can include a bar chart showing positive feedback for each user application, a usage overview of each user application, a fine tuning process, and a daily usage process. The positive feedback of each user application can indicate a percentage of users providing positive feedback regarding a particular model. The usage overview may provide information regarding the operational cost and/or response time associated with each model and user application. Additionally, the usage overview may indicate the number of times a particular user application was used, along with the feedback received (e.g., likes or dislikes). The daily usage may indicate how frequently or how many times a particular user application was used.

As shown in FIG. 25B, the user interface for A to Z testing 2500 may also include a description of the particular user applications being tested. For example, the user application alongside the particular LLM or global model it interfaces with, the particular use case the user application is being used for, what prompt augmentation techniques are being used, and a specified tone can be displayed and provided via the A to Z testing interface.

FIG. 25C provides another illustration of the user interface for A to Z testing 2500. As shown, the heat safety application received mixed feedback from users of the application, with four users indicating “likes” and two users indicating “dislikes.” In some embodiments, a user can be shown a variation of a user application based on a random or preset probability, a self adjusting scale, and the like.

In some embodiments, as illustrated in FIG. 25D the user interface for A to Z testing can moderate the percentage of users receiving a particular user application for testing based on past performance ratings of the user applications. The distribution percentage can be indicative of the percentage of users receiving a particular user application. For example, a user application that utilizes a particular model can be slowly presented to fewer users if it is more expensive, slower and/or receiving a lower performance rating than other user applications. Additionally, the user interface for A to Z testing can provide a back-end user with the ability to remove or select a particular user application for use with end-users. The disclosed user interface for A to Z testing can track usage overtime and observe dominant or subservient variations of user applications.

In some aspects, user feedback can be used to retrain or update the artificial intelligence models. For example, a score for an artificial intelligence model can be determined based on the user feedback. For instance, a count, weight, median, mean, or ratio between positive, neutral, or negative user feedback can be used to determine a score for the artificial intelligence model. The resulting score can be used to retrain and/or update the artificial intelligence models. In some aspects, the score for user feedback can be combined with contextual information that was provided to the artificial intelligence model, for example the settings or other information included in the parameter set. As discussed above, the contextual information can include, but is not limited to, the prompt engineering, chat application being used, chat tones being used, data being used, token limits, LLM settings, temperature, and the like.

Contextual information and metadata linking a particular parameter set to an artificial intelligence model can be used to fine-tune the artificial intelligence based model. For example, the payload or data that was provided to the artificial intelligence model that resulted in a response that was indicated as being “good” by user feedback can be provided to the artificial intelligence model to retrain it based on the good response in addition to the context it was generated in. In this manner, metadata and contextual data is linked to better responses and used to retrain the artificial intelligence model in a way that reduces the occurrence of hallucinations.

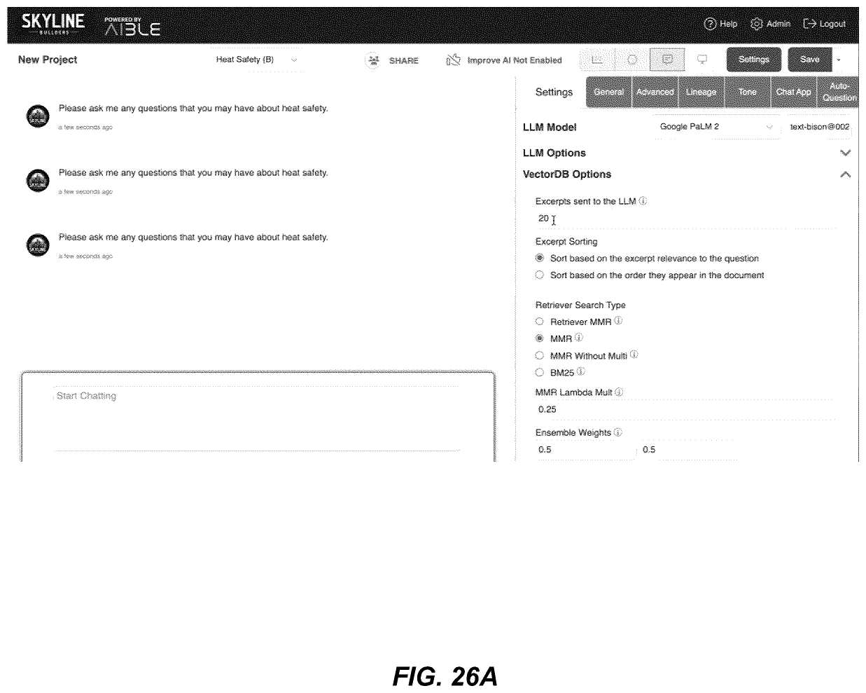

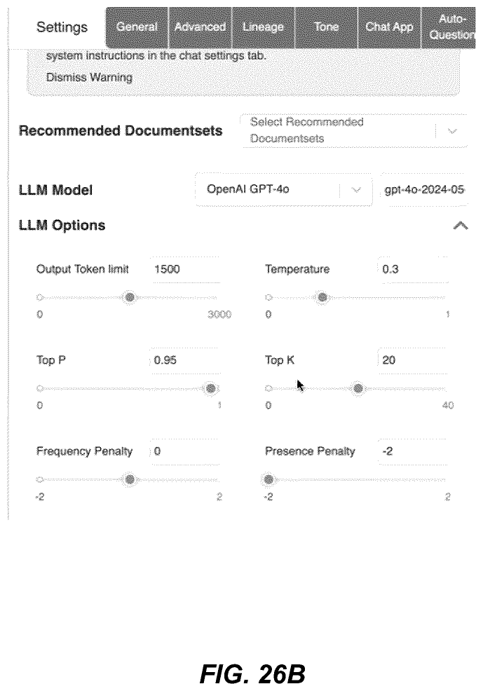

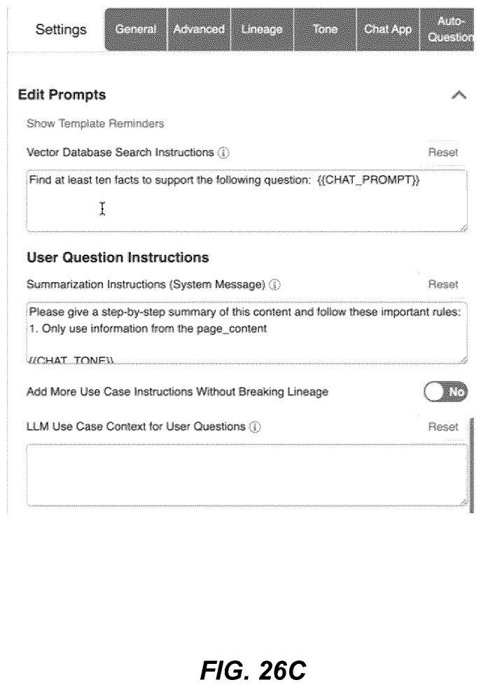

FIG. 26A-26C illustrate the various settings for the underlying user applications that can be evaluated for their contribution towards user application performance. As shown in FIG. 26A, an underlying user application can include settings pertaining to an LLM or a vector database. For example, the user application can specify the amount of data transmitted to the LLM for retrieval, the retriever search type and other parameters. As shown in FIG. 26B, parameters for the LLM model can be specified by the particular user application including, for example, but without limit, the output token limit, temperature, top p, top k, frequency penalty, presence penalty, and the like. FIG. 26C illustrates additional parameters than can be specified by the user interface such as prompts. As illustrated in FIGS. 26A-26C a user application can interface with an underlying informational model and/or a global model, including by determining the information that is sent to the respective models, customizing and adjusting parameters for how information is retrieved, and the like.

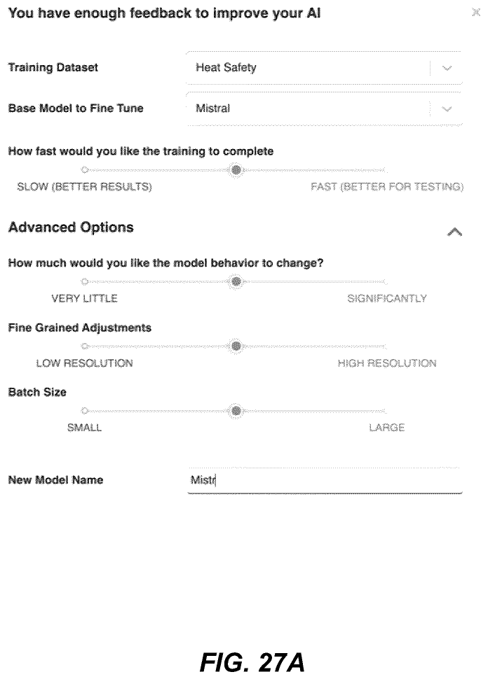

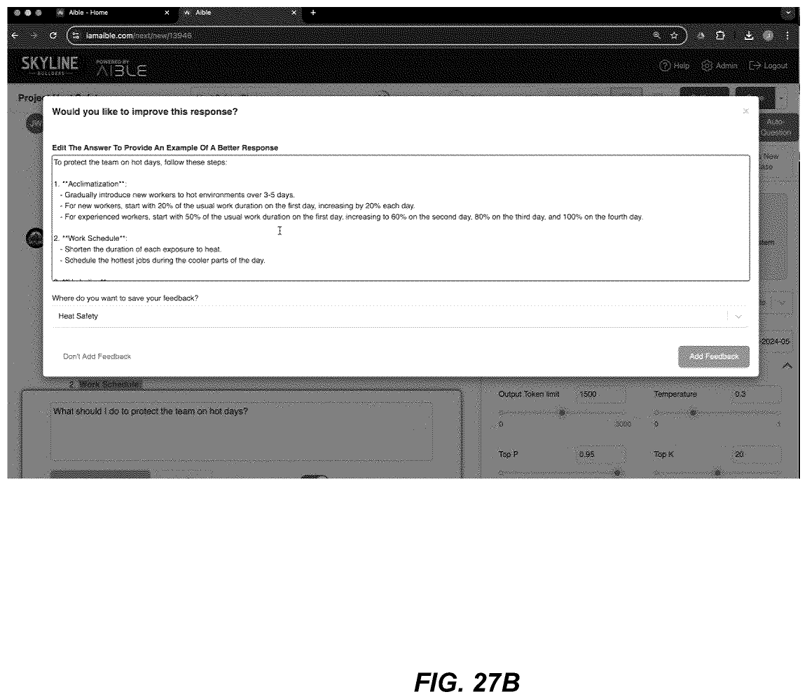

FIG. 27A provides an illustration of a user interface for fine-tuning. Fine-tuning may include the providing the user application and underlying informational models and/or global models with user feedback such as a positive, negative, neutral, thumbs up, thumbs down, or the like. In this manner user feedback can be used to create additional layers that interface between the informational model and global model that include domain specific information. For example, the user feedback for fine tuning can be provided by subject matter experts. Accordingly, the user feedback received from these experts can be used to generate domain specific information.

As shown in FIG. 27A, a back-end user can be provided with a training dataset, and base model that is eligible for fine tuning. In some embodiments, Low Rank Adaptation (LoRA) or similar techniques can be used to fine tune training models.

As illustrated in FIG. 27B user provided feedback can be used for fine tuning. For example, a user can provide edited answers of a better response and save the feedback for use in fine tuning.

In some aspects, a model and parameter selector 2304 can monitor performance across multiple users, use applications, and their underlying artificial intelligence models. In some embodiments, a back-end system can be configured to monitor performance across the platform and determine how parameter sets and their underlying artificial intelligence models are being utilized, how users are engaging with results or responses produced or output by the artificial intelligence models and the like.

For example, in some aspects the back end system can view user feedback across a plurality of models and parameter sets and identify models that are underperforming, overperforming, or the like. In some aspects, user feedback for a plurality of models that are run using a plurality of parameter sets can be compared to determine which combination of models and parameter sets are receiving better user feedback. In some aspects, the user feedback and model parameters can be linked to the objectives for the organization deploying the model. Models and parameter set combinations that do not meet a predefined threshold set by the organization may be removed from being displayed to a user for selection via the user interface. In some aspects, a user may be able to indicate preferences for their responses, and a model and parameter selector may select a combination of a model and/or parameter set that is likely to provide the user with a response or result from the model that the user is likely to favor, based on a comparison of historical data from a plurality of users, their indicated preferences, and their provided feedback on combinations of models and parameter sets.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing a prompt from a user interface of a user application, wherein the data is in natural language form;
generating data characterizing an enhanced prompt based on at least one of a type of an artificial intelligence based model interfacing with the user application, a setting of the artificial intelligence based model, or a configuration for an enterprise in which the artificial intelligence based model is deployed;
modifying the enhanced prompt when a change in the type of artificial intelligence based model, a change in the setting of the artificial intelligence based model, or a change in a configuration for an enterprise in which the artificial intelligence based model is deployed is determined to be above a threshold; and
providing the modified enhanced prompt to one or more applications interfacing with the artificial intelligence model.

2. The method of claim 1, further comprising:
determining a prompt response by providing the data characterizing the modified enhanced prompt to an artificial intelligence based model; and
providing the prompt response.

3. The method of claim 1, wherein the artificial intelligence based model comprises at least one of a foundational model, a multimodal model, a reinforcement learning model, a transfer learning model, or a large language model.

4. The method of claim 2, wherein the prompt response is provided to a user interface in natural language form.

5. The method of claim 2, wherein the prompt response is augmented with external data.

6. The method of claim 2, wherein providing the modified enhanced prompt to one or more applications interfacing with the artificial intelligence model further comprises:
associating the artificial intelligence model with one or more applications interacting with the artificial intelligence model; and
providing a change to the modified enhanced prompt to the one or more applications associated with the artificial intelligence model.

7. The method of claim 1, wherein generating data characterizing an enhanced prompt comprises historical prompt data, wherein the historical prompt data comprises at least one of prior prompts, prior responses, and user feedback indicating relevancy of prior responses.

8. The method of claim 1, further comprising:
displaying at least one of the prompt, the enhanced prompt, or the modified enhanced prompt in a graphical user interface.

9. The method of claim 1, wherein generating data characterizing an enhanced prompt comprises receiving few shot data and the method comprises providing few shot data to the artificial intelligence model.

10. The method of claim 2, wherein the prompt response is change-resistant.

11. The method of claim 1, wherein the setting of the artificial intelligence based model comprises at least one of a temperature, frequency penalty, presence penalty, top P-value, or top K-value.

12. The method of claim 1, wherein the enhanced prompt specifies visibility and access settings for the artificial intelligence based model.

13. The method of claim 6, further comprising:
linking one or more user applications to a first user application of the one or more applications interfacing with the artificial intelligence model; and
automatically modifying enhanced prompts for the linked one or more user applications responsive to the first user application receiving the provided modified enhanced prompt.

14. The method of claim 1, wherein the user application is configured to provide one or more of document summarization, natural language query, what's new analysis and/or analytics.

15. The method of claim 1, wherein the enhanced prompt comprises a dataset object, outcomes of the dataset object, and/or parameters for a prompt response.

16. The method of claim 15, wherein the parameters for the prompt response comprise a tone, a cadence, and/or narrative styles.

17. The method of claim 1, further comprising:
providing the modified enhanced prompts to a user via a graphical user interface; and
receiving feedback to the provided modified enhanced prompts from the user via the graphical user interface, wherein the feedback comprises text, icon selections and/or adjustments to parameter settings.

18. The method of claim 17, further comprising:
generating training data for at least one of an enhanced prompt generator and/or the artificial intelligence based model based on the modified enhanced prompt when the received feedback is positive.

19. A method comprising:
receiving data comprising one or more parameter sets for a user application interfacing with an artificial intelligence based model, wherein a parameter set among the one or more parameter sets comprises one or more values indicating at least one of a type of the artificial intelligence based model, a setting of the artificial intelligence based model, or a configuration of the artificial intelligence based model;
generating data characterizing performance of the user application for the one or more parameter sets; and
providing the data characterizing performance of the user application.

20. The method of claim 19, further comprising:
receiving user feedback characterizing performance of the user application.

21. The method of claim 20, further comprising:
updating the artificial intelligence based model using at least one of the received user feedback and/or the provided parameter set.

22. The method of claim 19, wherein the artificial intelligence based model comprises at least one of a foundational model, a multimodal model, a reinforcement learning model, a transfer learning model, or a large language model.

23. The method of claim 19, further comprising:
monitoring the performance of one or more user applications including the user application for the one or more parameter sets.

24. The method of claim 19, further comprising:
displaying at least one of the parameter set and/or data characterizing performance of the user application in a graphical user interface.

25. The method of claim 20, further comprising: updating a prompt generator using at least one of the received user feedback and/or the provided parameter set.

26. The method of claim 19, wherein the configuration of the artificial intelligence based model comprises a chat tone indicating that a response generated by the user application is at least one of: a narrative format, a bullet point list, a story format, in a short and punchy format, or a business format.

27. The method of claim 19, wherein the configuration of the artificial intelligence based model indicates whether the artificial intelligence based model recalls previous queries and their respective answers for context.

28. The method of claim 19, wherein the configuration of the artificial intelligence based model specifies access and security parameters for the artificial intelligence based model.

29. A system comprising:
at least one data processor; and
memory coupled to the at least one data processor and storing instructions which, when executed by the at least one data processor, causes the at least one data processor to perform operations comprising:
receiving data characterizing a prompt from a user interface of a user application associated with an artificial intelligence based model, wherein the data is in natural language form;
generating data characterizing an enhanced prompt based on at least one of a type of the artificial intelligence based model, a setting of the artificial intelligence based model, or a configuration for an enterprise in which the artificial intelligence based model is deployed;
modifying the enhanced prompt when a change at least one of the type of artificial intelligence based model, the setting of the artificial intelligence based model, or a configuration for an enterprise in which the artificial intelligence based model is deployed is determined to be above a threshold; and
providing the modified enhanced prompt to one or more applications interfacing with the artificial intelligence model.

30. The system of claim 29 wherein the operations further comprise:
determining a prompt response by providing the data characterizing the modified enhanced prompt to an artificial intelligence based model; and
providing the prompt response.

31. The system of claim 29, wherein the operations further comprise:
receiving data comprising one or more parameter sets for a user application interfacing with an artificial intelligence based model, wherein a parameter set among the one or more parameter sets comprises one or more values indicating at least one of the type of the artificial intelligence based model, a setting of the artificial intelligence based model, or a configuration for an enterprise in which the artificial intelligence based model is deployed;
generating data characterizing performance of the user application for the one or more parameter sets; and
providing the data characterizing performance of the user application.

32. The system of claim 29, wherein the operations further comprise:
receiving user feedback characterizing performance of the user application.

33. The system of claim 30, wherein the operations further comprise:
updating the artificial intelligence based model using at least one of the received user feedback and/or the provided parameter set.
